(19) United States
(12) Patent Application Publication
(10) Pub. No.: US 2022/0326916 A1
(43) Pub. Date: Oct. 13, 2022

(54) VISUALIZATION METHOD FOR SOFTWARE ARCHITECTURE AND APPARATUS

(71) Applicant: Huawei Cloud Computing Technologies Co., Ltd., Guizhou (CN)

(72) Inventor: Shaobing YANG, Shanghai (CN)

(21) Appl. No.: 17/848,078

(22) Filed: Jun. 23, 2022

Related U.S. Application Data
(63) Continuation of application No. PCT/CN2020/134338, filed on Dec. 7, 2020.

(30) Foreign Application Priority Data
Dec. 23, 2019 (CN) 201911336428.2

(51) Int. Cl. G06F 8/34; G06F 8/38; G06F 8/20

(52) U.S. Cl. CPC G06F 8/34; G06F 8/38; G06F 8/20

(57) ABSTRACT

A visualization method for a software architecture and an apparatus are provided. After receiving architecture information of software, a display apparatus may first construct a three-dimensional view based on the architecture information. After constructing the three-dimensional view, the display apparatus may display the three-dimensional view, and may further display a two-dimensional view. The architecture information indicates that the software includes one or more functional components, and the functional component may be represented by using a stereoscopic graph in the three-dimensional view. When viewing the three-dimensional view, a user may further perform a series of operations on the three-dimensional view. In response to the operation of the user on the three-dimensional view, the display apparatus may adjust the three-dimensional view, and display an adjusted three-dimensional view. The software architecture may be more intuitively displayed by using the three-dimensional view, and the software architecture may be flexibly adjusted by using the three-dimensional view.

### CROSS-REFERENCE TO RELATED APPLICATIONS

This application is a continuation of International Application No. PCT/CN2020/134338, filed on Dec. 7, 2020, which claims priority to Chinese Patent Application No. 201911336428.2, filed on Dec. 23, 2019. The disclosures of the aforementioned applications are hereby incorporated by reference in their entireties.

### TECHNICAL FIELD

This application relates to the field of computer technologies, and in particular, to a visualization method for a software architecture and an apparatus.

### BACKGROUND

One piece of software may be divided into a plurality of different functional components, and a software architecture is used to describe composition of the software and an association relationship between the functional components in the software. To more intuitively display a software architecture of the piece of software, currently, a two-dimensional view may be used to display each functional component in the software in a two-dimensional plane, and display the software architecture by using a shape and a connection line. For example, in the two-dimensional view, the shape may be used to represent a functional component, and different shapes represent different functional components. The connection line is used to represent an association relationship between the functional components.

However, the two-dimensional view is limited by dimensions, and a graph in a formed two-dimensional view cannot be rotated or translated. A method of displaying the software architecture in the two-dimensional view is not flexible and intuitive.

### SUMMARY

This application provides a visualization method for a software architecture and an apparatus, to improve flexibility and intuitiveness of displaying the software architecture.

According to a first aspect, an embodiment of this application provides a visualization method for a software architecture. The method may be performed by a display apparatus. The method includes: When receiving architecture information of software, the display apparatus may first construct a three-dimensional view based on the architecture information, and may optionally construct a two-dimensional view. After constructing the three-dimensional view, the display apparatus may display the three-dimensional view, and may further display a two-dimensional view. The architecture information indicates that the software includes one or more functional components, and the functional component may be represented by using a stereoscopic graph in the three-dimensional view.

When viewing the three-dimensional view, a user may further perform some operations on the three-dimensional view. In response to the operation of the user on the three-dimensional view, the display apparatus may adjust the three-dimensional view, and display an adjusted three-dimensional view. The display apparatus may also adjust the two-dimensional view, and display the two-dimensional view when triggered by the user.

According to the foregoing method, the display apparatus may display the software architecture by using a three-dimensional view. This display manner is more intuitive. In addition, the three-dimensional view may be adjusted, so that the software architecture can be adjusted flexibly and conveniently.

In a possible design, when adjusting the three-dimensional view in response to the operation of the user on the three-dimensional view, the display apparatus may first update the architecture information of the software, and then adjust the three-dimensional view by using updated architecture information of the software.

According to the foregoing method, the display apparatus adjusts the three-dimensional view by updating the architecture information. This adjustment manner is more convenient.

In a possible design, the architecture information of the software is used to describe the software architecture, and the architecture information of the software includes at least one of the following: a name of the functional component in the software, an association relationship between functional components in the software, a computing resource occupied by the functional component, an affiliation relationship between the functional components in the software, and structure information of the functional component.

According to the foregoing method, richer information included in the architecture information of the software indicates more information displayed in the three-dimensional view, so that the three-dimensional view is more intuitive.

In a possible design, there are many manners for displaying the software architecture in the three-dimensional view. For example, a connection line between stereoscopic graphs in the three-dimensional view may indicate the association relationship between functional components in the software, the stereoscopic graph in the three-dimensional view may indicate the computing resource occupied by the functional component in the software, an inclusion relationship between the stereoscopic graphs in the three-dimensional view may indicate the affiliation relationship between the functional components in the software, and a three-dimensional graph in the stereoscopic graphs in the three-dimensional view may indicate an instance in the functional component.

According to the foregoing method, the three-dimensional view may display relatively much information, and the information may be displayed in a graphical manner in the three-dimensional view. The three-dimensional view can display the software architecture more intuitively and flexibly.

In a possible design, there are many operations of the user on the three-dimensional view. For example, the user may perform a rotation operation on the stereoscopic graph in the three-dimensional view. The display apparatus may rotate the stereoscopic graph in response to the rotation operation of the user on the stereoscopic graph in the three-dimensional view.

According to the foregoing method, the user may change a display direction of the stereoscopic graph by rotating the stereoscopic graph, to fully view a functional component corresponding to the stereoscopic graph.

In a possible design, there are many operations of the user on the three-dimensional view. For example, the user may perform a moving operation on the stereoscopic graph in the three-dimensional view. The display apparatus moves the stereoscopic graph in response to the moving operation of the user on the stereoscopic graph in the three-dimensional view.

According to the foregoing method, the user may change a display position of the stereoscopic graph by moving the stereoscopic graph, to change the affiliation relationship between the functional components, and more clearly view the functional component corresponding to the stereoscopic graph.

In a possible design, there are many manners in which the stereoscopic graph in the three-dimensional view indicates the computing resource occupied by the functional component in the software. For example, a cross-sectional area of the stereoscopic graph may indicate a computing resource occupied by the functional component, and a height of the stereoscopic graph may indicate a quantity of instances in the functional component. For another example, three edges in different directions in the stereoscopic graph may separately indicate a computing resource occupied by the functional component.

There are many types of operations of the user on the three-dimensional view. For example, the user may perform a scaling operation on the stereoscopic graph in the three-dimensional view. A display module may scale the stereoscopic graph in response to the scaling operation of the user on the stereoscopic graph in the three-dimensional view, to adjust the computing resource occupied by the functional component corresponding to the stereoscopic graph.

According to the foregoing method, the display apparatus can conveniently change, by scaling the stereoscopic graph, the computing resource occupied by the functional component.

In a possible design, when an edge of the stereoscopic graph is used to indicate different computing resources occupied by the functional component, if the user performs a stretching operation on the edge of the stereoscopic graph in the three-dimensional view, the display apparatus stretches the edge in response to the stretching operation of the user on the edge of the stereoscopic graph in the three-dimensional view, to adjust the computing resource corresponding to the edge occupied by the functional component corresponding to the stereoscopic graph.

If the user performs a stretching operation on a vertex of the stereoscopic graph in the three-dimensional view, the display apparatus proportionally scales all edges of the stereoscopic graph in a direction of the stretching operation in response to the stretching operation of the user on the vertex of the stereoscopic graph in the three-dimensional view, to adjust a computing resource corresponding to each edge occupied by the functional component corresponding to the stereoscopic graph.

According to the foregoing method, the display apparatus can conveniently change, by scaling the edge of the stereoscopic graph, different computing resources occupied by the functional component.

In a possible design, the stereoscopic graph in the three-dimensional view includes a three-dimensional graph, and a three-dimensional graph included in a stereoscopic graph indicates an instance in a functional component corresponding to the stereoscopic graph. The user may perform an operation such as moving, rotating, or scaling on the three-dimensional graph in the three-dimensional view, and the display apparatus adjusts the three-dimensional graph in response to the operation of the user on the three-dimensional graph in the three-dimensional view.

For example, the display apparatus may scale the three-dimensional graph in response to a scaling operation of the user on the three-dimensional graph in the three-dimensional view, to adjust a computing resource occupied by the instance indicated by the three-dimensional graph.

According to the foregoing method, the display apparatus can conveniently change, by adjusting the three-dimensional graph, the computing resource occupied by the instance in the functional component.

In a possible design, there are many manners in which the three-dimensional graph in the three-dimensional view indicates the computing resource occupied by the instance in the functional component. For example, a cross-sectional area of the three-dimensional graph may indicate a computing resource occupied by the instance in the functional component, and a height of the three-dimensional graph may indicate another computing resource occupied by the instance in the functional component. For another example, three edges in different directions in the three-dimensional graph may separately indicate a computing resource occupied by the instance in the functional component.

When the user performs a scaling operation on the three-dimensional graph in the three-dimensional view, if the user performs a stretching operation on an edge of the three-dimensional graph in the three-dimensional view, the display apparatus scales the edge of the three-dimensional graph in a direction of the stretching operation in response to the stretching operation of the user on the edge of the three-dimensional graph, to adjust the computing resource corresponding to the edge occupied by the instance corresponding to the three-dimensional graph. If the user performs a stretching operation on a vertex of the three-dimensional graph in the three-dimensional view, the display apparatus proportionally scales all edges of the three-dimensional graph in a direction of the stretching operation in response to the stretching operation of the user on the vertex of the three-dimensional graph in the three-dimensional view, to adjust computing resources corresponding to all edges occupied by the instance corresponding to the three-dimensional graph.

According to the foregoing method, the display apparatus can conveniently change, by scaling the edge or the vertex of the three-dimensional graph, different computing resources occupied by the instance in the functional component.

In a possible design, after adjusting the three-dimensional view, the display apparatus may further update the two-dimensional view based on the adjusted three-dimensional view. The two-dimensional view is pre-constructed and is used to display the software architecture. A two-dimensional graph in the two-dimensional view represents a functional component in the software architecture, a connection line between two-dimensional graphs may represent an association relationship between functional components, and an inclusion relationship between the two-dimensional graphs may represent an affiliation relationship between the functional components.

After the update, the display apparatus may display an updated two-dimensional view when triggered by the user.

According to the foregoing method, in addition to displaying the three-dimensional view, the display apparatus may further display the two-dimensional view, and manners of displaying the software architecture are more diversified.

In a possible design, the display apparatus may receive update information of the software architecture. The update information includes a name of a changed functional component in the software and a change manner of the changed functional component. The update information may be sent by another apparatus, or may be generated when the user performs an operation on the three-dimensional view. The display apparatus may update the three-dimensional view or the two-dimensional view based on the update information, and display the updated three-dimensional view or two-dimensional view when triggered by the user.

According to the foregoing method, the display apparatus can update the three-dimensional view or the two-dimensional view in time, so that the three-dimensional view and the two-dimensional view can more accurately display the software architecture.

According to a second aspect, an embodiment of this application further provides a display apparatus. For beneficial effects, refer to the description of the first aspect. Details are not described herein again. The apparatus has a function of implementing the behavior in the method example in the first aspect. The function may be implemented by hardware, or may be implemented by hardware executing corresponding software. The hardware or the software includes one or more modules corresponding to the foregoing functions. In a possible design, a structure of the apparatus includes a receiving module, a construction module, and a display module. These modules may perform corresponding functions in the method example in the first aspect. For details, refer to detailed descriptions in the method example. Details are not described herein again.

According to a third aspect, an embodiment of this application further provides a computing device. The computing device includes a processor and a memory, and may further include a communication interface and a display. The processor executes program instructions in the memory to perform the method according to any one of the first aspect or the possible implementations of the first aspect. The memory is coupled to the processor, and stores program instructions and data that are necessary in a process of determining traffic flows. The communication interface is configured to communicate with another device, for example, receive architecture information or update information of software. The display is configured to display a three-dimensional view or a two-dimensional view to a user when triggered by the processor.

According to a fourth aspect, this application provides a computing device cluster. The computing device cluster includes at least one computing device. Each computing device includes a memory and a processor. The processor in the at least one computing device is configured to access code in the memory to perform the method according to any one of the first aspect or the possible implementations of the first aspect.

According to a fifth aspect, this application provides a non-transient readable storage medium. When the non-transient readable storage medium is executed by a computing device, the computing device performs the method according to any one of the first aspect or the possible implementations of the first aspect. The storage medium stores a program. The storage medium includes but is not limited to a volatile memory, for example, a random access memory, or a nonvolatile memory, such as a flash memory, a hard disk drive (hard disk drive, HDD), and a solid state drive (solid state drive, SSD).

According to a sixteenth aspect, this application provides a computing device program product. The computing device program product includes computer instructions. When the computer instructions are executed by a computing device, the computing device performs the method according to any one of the first aspect or the possible implementations of the first aspect. The computer program product may be a software installation package. When the method according to any one of the first aspect or the possible implementations of the first aspect needs to be used, the computer program product may be downloaded to and executed on the computing device.

According to a seventh aspect, this application further provides a computer chip. The chip is connected to a memory, and the chip is configured to read and execute a software program stored in the memory, to perform the method according to any one of the first aspect or the possible implementations of the first aspect.

### BRIEF DESCRIPTION OF DRAWINGS

FIG. 1 is a schematic diagram of a structure of a display apparatus according to this application;

FIG. 2A and FIG. 2B are schematic diagrams of two-dimensional logical views according to this application;

FIG. 3 is a schematic diagram of a two-dimensional running view according to this application;

FIG. 4 is a schematic diagram of a two-dimensional deployment view according to this application;

FIG. 5A is a schematic diagram of a three-dimensional logical view according to this application;

FIG. 5B to FIG. 5H are schematic diagrams of adjusting a three-dimensional logical view according to this application;

FIG. 6 is a schematic diagram of a three-dimensional running view according to this application;

FIG. 7 is a schematic diagram of a three-dimensional deployment view according to this application;

FIG. 8A and FIG. 8B are schematic diagrams of another three-dimensional logical view according to this application;

FIG. 8C to FIG. 8F-2 are schematic diagrams of adjusting a three-dimensional logical view according to this application;

FIG. 9 is a schematic diagram of another two-dimensional deployment view according to this application;

FIG. 10 is a schematic diagram of still another three-dimensional logical view according to this application;

FIG. 11 is a schematic diagram of a three-dimensional mapping view according to this application;

FIG. 12 is a schematic diagram of a view construction method according to this application;

FIG. 13 is a schematic diagram of an interface for displaying a software architecture according to this application;

FIG. 14 is a schematic diagram of another interface for displaying a software architecture according to this application;

FIG. 15 is a schematic diagram of a view update method according to this application;

FIG. 16 is a schematic diagram of a structure of a computer cluster according to this application; and

FIG. 17 is a schematic diagram of a structure of a system according to this application.

### DESCRIPTION OF EMBODIMENTS

Generally, one piece of software may be logically split into a plurality of functional components, and each functional component can be used to implement one or a series of related functions. Each functional component may also be divided into functional components of a smaller granularity. The functional components in embodiments of this application include but are not limited to a module, a component, a service, a microservice, and an instance.

For ease of understanding, the following describes the foregoing several different types of functional components.

1. Module (module): The module is a component obtained by dividing software based on functions. A software division manner is not limited in embodiments of this application. For example, ticket booking software can be divided into a database module, a matching module, and a payment module based on functions. The database module stores information such as departure time of different trains, time of each stop point of each train, quantities and prices of remaining tickets of trains. The matching module is configured to match, based on a requirement of a user, a train that meets the requirement from a database. The payment module may indicate, when triggered by the user, the user to pay for the ticket.

2. Component (component): The component can be a part of a module in a software architecture. In embodiments of this application, the component may be an independent part logically divided based on a programming language such as C/C++. For example, the component may be an independent .so or .dll file.

3. Instance (instance): The instance may be a module, a component, or a computing entity on which a module or a component is deployed. The computing entity may be a virtual machine, a container, or another entity that provides a computing capability. A computing resource occupied by each instance includes one or more of the following: a processor, memory, disk space, and bandwidth.

Each functional component includes at least one instance. Instances included in one functional component may be the same. In this case, the same instances in a software architecture are aggregated into a unified functional component. For example, a software architecture of the ticket booking software includes a plurality of database modules, a plurality of matching modules, and a plurality of payment modules. In an implementation, the software architecture of the ticket booking software includes three functional components. One functional component includes a plurality of database modules, another functional component includes a plurality of matching modules, and another functional component includes a payment module. In another implementation, the software architecture of the ticket booking software includes three functional components. One functional component includes a plurality of computing entities running the database, another functional component includes a plurality of computing entities running the matching module, and another functional component includes a plurality of computing entities running the payment module. Instances included in one functional component may be different. In this case, instances associated with functions in the software architecture are aggregated into the unified functional component. For example, the software architecture of the ticket booking software includes three database modules, three matching modules, three payment modules, and one load balancing module. In this case, the software architecture of the ticket booking software includes four functional components. Each of functional components 1 to 3 includes one database module, one matching module, and one payment module, and a functional component 4 includes the load balancing module. The load balancing module in the functional component 4 is configured to perform load balancing in the functional components 1 to 3. In another implementation, the software architecture of the ticket booking software includes four functional components. Each of the functional components 1 to 3 includes one computing entity running the database module, one computing entity running the matching module, and one computing entity running the payment module. The functional component 4 includes a computing entity running the load balancing module.

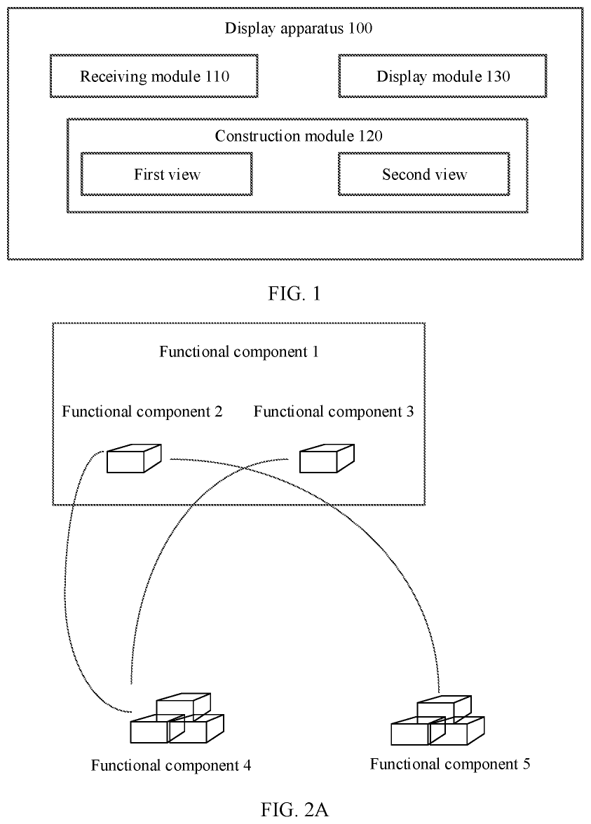

An embodiment of this application provides a visualization method for a software architecture. The method is performed by a display apparatus. FIG. 1 is a schematic diagram of a structure of a display apparatus according to this embodiment of this application. The display apparatus 100 includes a receiving module 110, a construction module 120, and a display module 130.

The receiving module 110 may receive architecture information of to-be-displayed software. The architecture information includes but is not limited to names of functional components included in the software and an association relationship between the functional components. Optionally, the architecture information may further include structure information of the functional component.

The construction module 120 constructs a three-dimensional view based on the architecture information. Optionally, the construction module 120 may further construct a two-dimensional view.

The display module 130 is configured to display the three-dimensional view when triggered by a user, and the display module 130 may further adjust the three-dimensional view in response to an operation of the user.

In this embodiment of this application, the software architecture is not limited to the two-dimensional view, but views in two different dimensions may be constructed based on the architecture information of the software. When triggered by the user, the three-dimensional view may be displayed based on a requirement of the user. In this embodiment of this application, the software architecture may be displayed by using the three-dimensional view. Compared with the two-dimensional view, the three-dimensional view is more intuitive and can display more information, so that flexibility of displaying the software architecture can be effectively improved.

Generally, an architecture view may be classified into a logical view, a running view, a deployment view, and the like based on information displayed in the architecture view. The logical view mainly displays an association relationship and an affiliation relationship between the functional components in the software. The association relationship refers to information interaction and a connection between the functional components. The affiliation relationship refers to an inclusion relationship of the functional components, and may be understood as further refinement of the functional components.

The running view mainly displays a running status, for example, faulty or normal, of the functional component in the software or a running status of an instance in the functional component.

The deployment view mainly displays a position in which the functional component is deployed in the software, for example, a server and a geographical area in which the functional component is located.

In terms of a dimension of the architecture view, the architecture view may be classified into a two-dimensional view, a three-dimensional view, and the like. In this embodiment of this application, the architecture view for displaying the software may be classified into two types in terms of the dimension: the two-dimensional view and the three-dimensional view. The following describes manners of displaying the software architecture by using the two-dimensional view and the three-dimensional view.

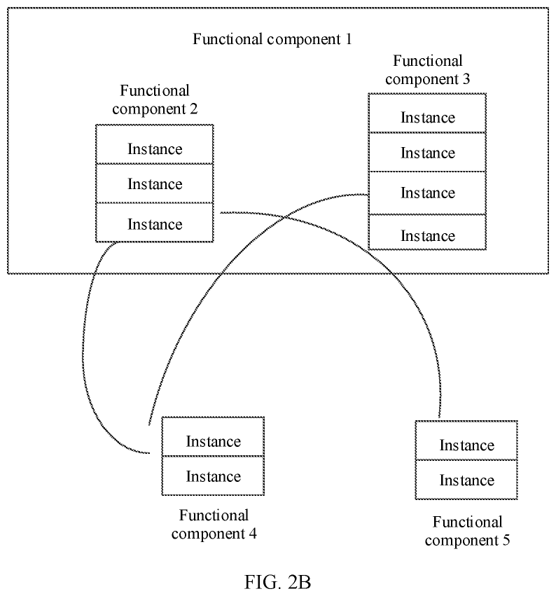

FIG. 2A shows a two-dimensional view of a software architecture. In the two-dimensional view, a two-dimensional graph may be used to represent a functional component in the software architecture (that is, one functional component corresponds to one two-dimensional graph), a connection line between two-dimensional graphs may represent an association relationship between functional components, and an inclusion relationship between the two-dimensional graphs may represent an affiliation relationship between the functional components.

The two-dimensional view shown in FIG. 2A includes five functional components: a functional component 1, a functional component 2, a functional component 3, a functional component 4, and a functional component 5. The functional component 1 is represented by using a linear box, and the functional component 2, the functional component 3, the functional component 4, and the functional component 5 are represented by using specific two-dimensional icons. The linear box includes two-dimensional icons representing the functional component 2 and the functional component 3, indicating an affiliation relationship between the functional component 1 and the functional component 2 and the functional component 3. In other words, the functional component 1 includes the functional component 2 and the functional component 3. There is a connection line between the two-dimensional icon representing the functional component 2 and two-dimensional icons representing the functional component 4 and the functional component 5, indicating that the functional component 2 is associated with the functional component 4 and the functional component 5. Similarly, the functional component 3 is associated with the functional component 5.

Some functional components in the two-dimensional logical view shown in FIG. 2A are represented by using two-dimensional icons, and it is inconvenient to divide the two-dimensional icons. Consequently, internal structures of these functional components cannot be further displayed. In a possible implementation, all functional components in the two-dimensional view may alternatively be represented by using linear boxes. In this way, after the linear boxes are divided, a plurality of components obtained by dividing the linear boxes may be used to represent the internal structures of the functional components. FIG. 2B is a two-dimensional view of a software architecture. The two-dimensional view includes five functional components: a functional component 1, a functional component 2, a functional component 3, a functional component 4, and a functional component 5. These five functional components are represented by linear boxes. The linear box corresponding to the functional component 1 includes linear boxes representing the functional component 2 and the functional component 3, indicating an affiliation relationship between the functional component 1 and the functional component 2 and the functional component 3. In other words, the functional component 1 includes the functional component 2 and the functional component 3. There is a connection line between the linear box representing the functional component 2 and linear boxes representing the functional component 4 and the functional component 5, indicating that the functional component 2 is associated with the functional component 4 and the functional component 5. Similarly, the functional component 3 is associated with the functional component 5. In addition, the linear box representing the functional component 2 is further divided into three same small linear boxes, and each small linear box may represent one instance of the functional component, indicating that the functional component 2 includes three instances. Similarly, the functional component 3 includes four instances. The functional component 4 includes two instances, and the functional component 5 includes two instances. The two-dimensional view displays as much information as possible.

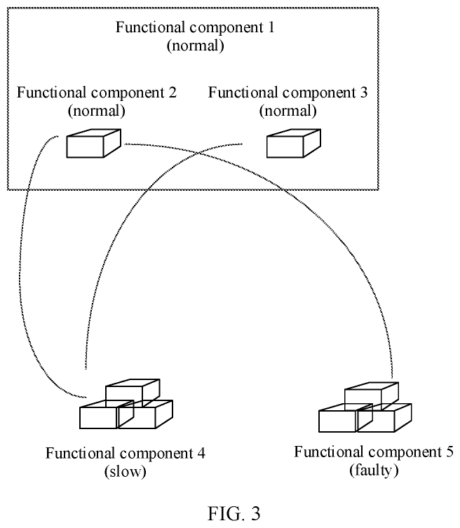

The two-dimensional views shown in FIG. 2A and FIG. 2B mainly display the association relationship and the inclusion relationship between the functional components in the software, and may be considered as two-dimensional logical views of the software architecture. Because a running view needs to display a running status of a functional component, currently, a running status of the functional component in the two-dimensional view may be displayed by using text information, and a running status of each functional component is displayed based on the two-dimensional logical view by using the text information. As shown in FIG. 3, a running status of each functional component is displayed by using a text next to a name of the functional component in FIG. 3. The text in FIG. 3 shows that the functional component 1, the functional component 2, and the functional component 3 run normally, the functional component 5 is faulty, and the functional component 4 runs slowly.

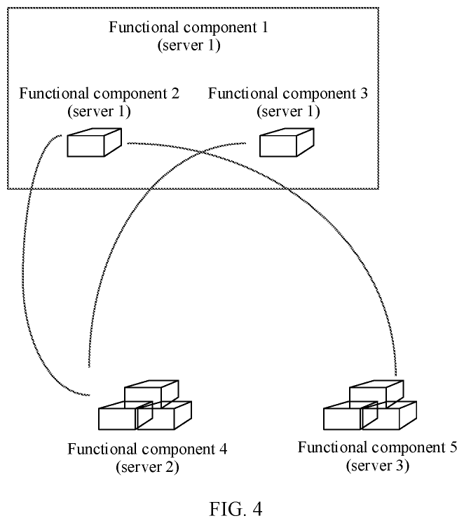

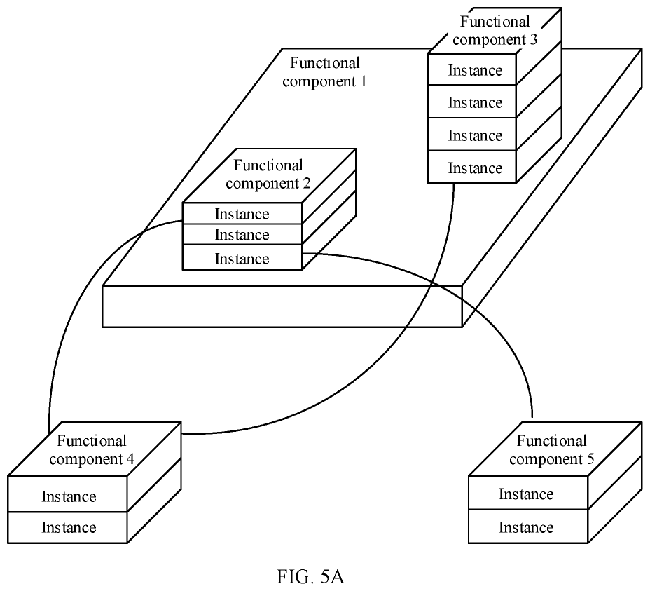

A deployment view displays a deployment position of a functional component. A deployment position of the functional component in the two-dimensional view may also be displayed based on the two-dimensional logical view by using text information. As shown in FIG. 4, a deployment position of each functional component is displayed by using a text next to the functional component in FIG. 4. The text in FIG. 4 shows that the functional component 1, the functional component 2, and the functional component 3 are deployed in a server 1, the functional component 5 is deployed in a server 3, and the functional component 4 is deployed in a server 2.

In FIG. 2A to FIG. 4, the two-dimensional view is limited by dimensions, information that can be displayed is limited, and a display manner is not vivid and intuitive enough.

The following describes the three-dimensional view of the software architecture according to this embodiment of this application. Instances in the functional component are the same or different, and manners of displaying the software architecture by using the three-dimensional view are different. The following separately provides descriptions.

Manner 1: Instances in the functional component are different, and the instances in the functional component cooperate with each other to implement a function of the functional component.

In the three-dimensional view, a stereoscopic graph may be used to represent the functional component in the software architecture, and a connection line between the stereoscopic graphs may represent an association relationship between the functional components. An inclusion relationship between the stereoscopic graphs can represent an affiliation relationship between the functional components. An internal composition of the stereoscopic graph may represent the instance in the functional component.

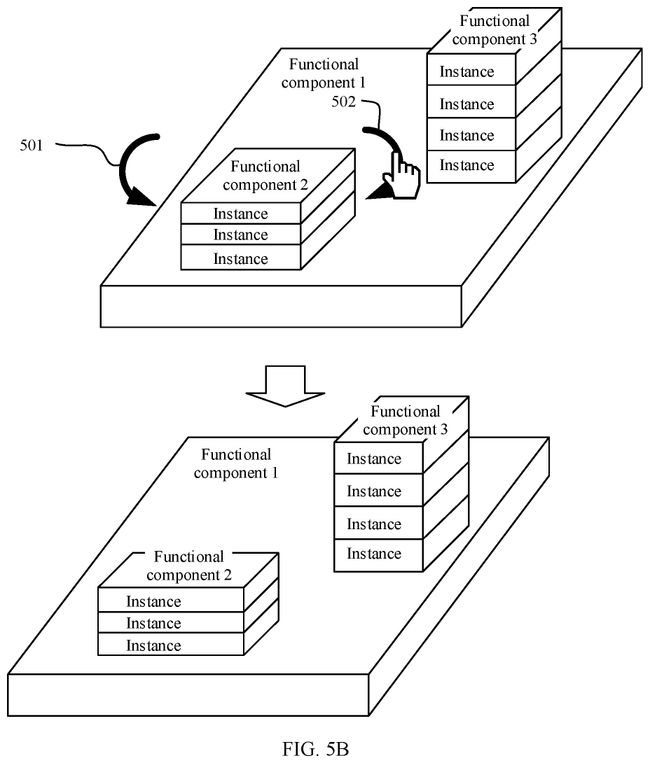

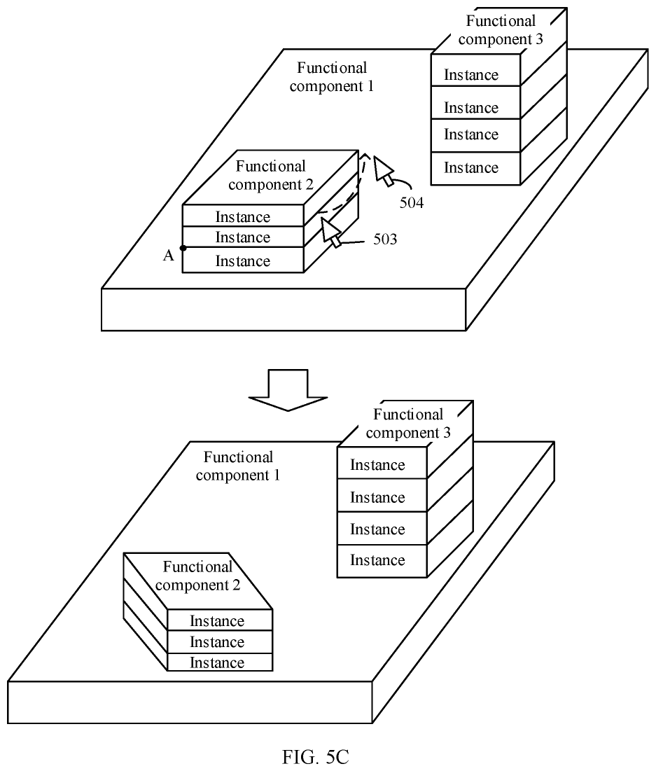

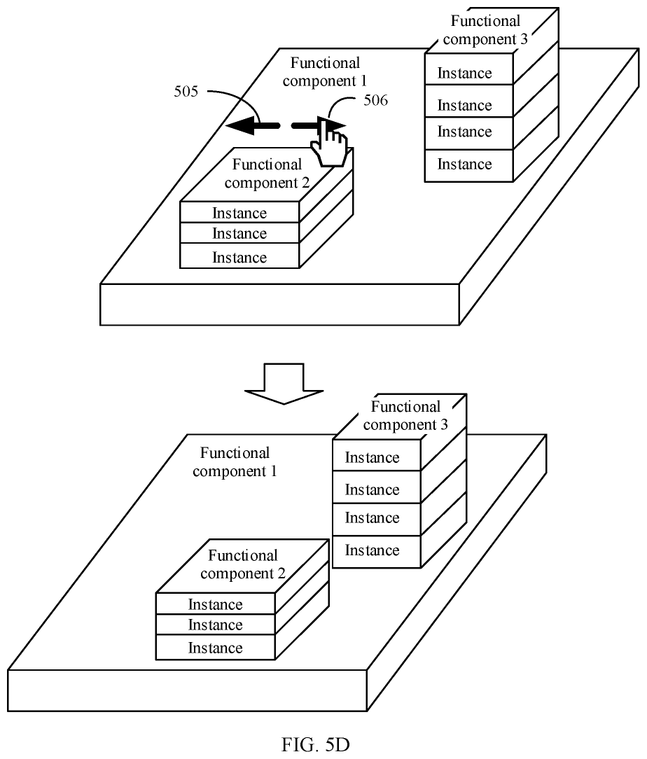

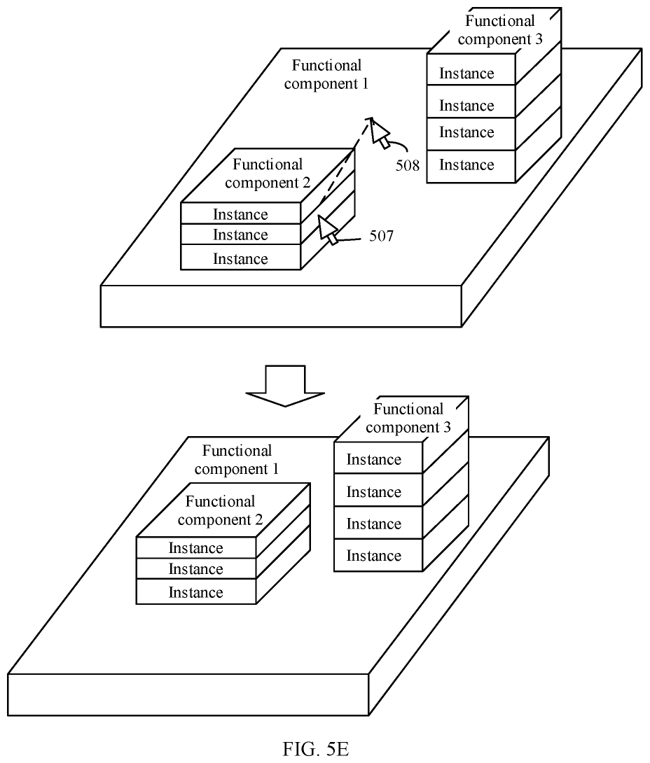

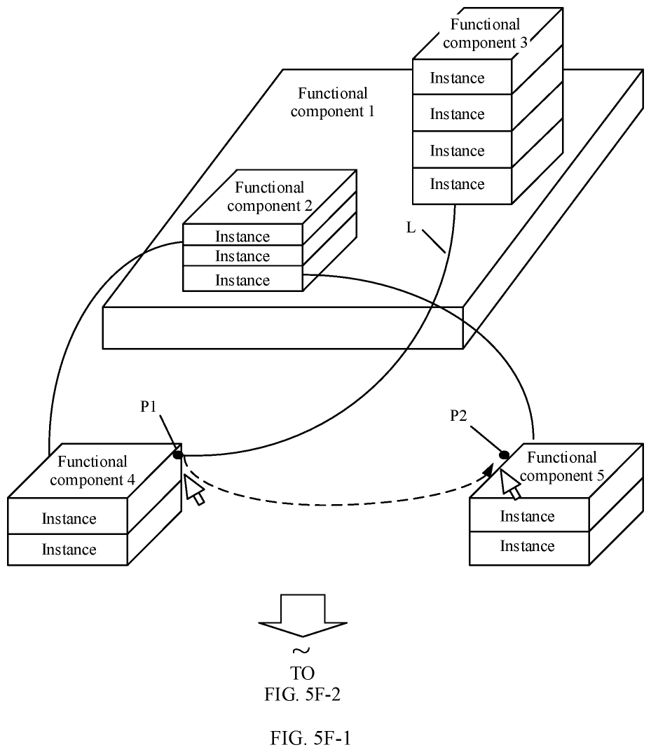

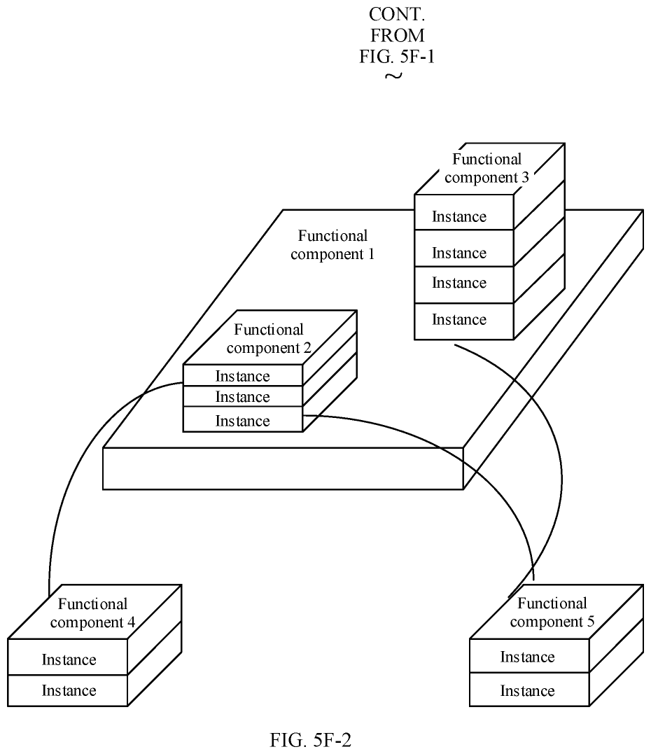

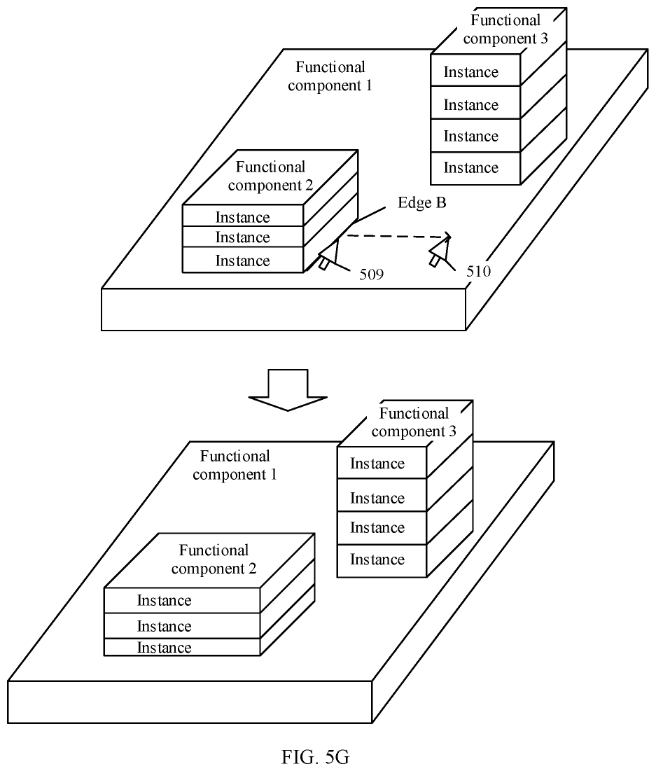

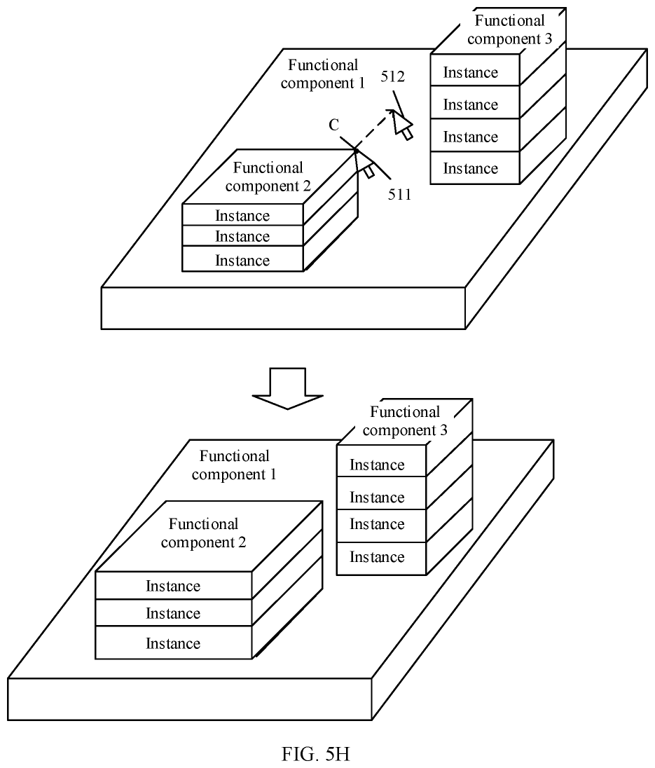

FIG. 5A is a three-dimensional view of a software architecture according to an embodiment of this application. The three-dimensional view includes five functional components: a functional component 1, a functional component 2, a functional component 3, a functional component 4, and a functional component 5. The functional component 1 is represented by using a flat cuboid, and the functional component 2, the functional component 3, the functional component 4, and the functional component 5 are represented by using relatively high cuboids. Cuboids representing the functional component 2 and the functional component 3 are placed on the flat cuboid, indicating an affiliation relationship between the functional component 1 and the functional component 2 and the functional component 3. In other words, the functional component 1 includes the functional component 2 and the functional component 3, and the functional component 2 and the functional component 3 cooperate with each other to implement a function implemented by the functional component 1. There is a connection line between the cuboid representing the functional component 2 and cuboids representing the functional component 4 and the functional component 5, indicating that the functional component 2 is associated with the functional component 4 and the functional component 5. For example, the functional component 2 may exchange information with the functional component 4 and the functional component 5. Similarly, the functional component 3 is associated with the functional component 5. In addition, the cuboid representing the functional component 2 is further divided into three same small cuboids, and each small cuboid may represent one instance of the functional component, indicating that the functional component 2 includes three instances, and the three instances included in the functional component 2 cooperate with each other to implement a function implemented by the functional component 2. Similarly, the functional component 3 includes four instances. The functional component 4 includes two instances, and the functional component 5 includes two instances.

The three-dimensional view shown in FIG. 5A mainly displays an association relationship and an inclusion relationship between the functional components in the software, and may be considered as a three-dimensional logical view of the software architecture.

The display module 130 may display the three-dimensional logical view shown in FIG. 5A to a user. When viewing the three-dimensional logical view, the user may further perform some operations on the three-dimensional logical view. The operations include but are not limited to: rotation, translation, and scaling. In response to an operation of the user, the construction module 120 may perform operations such as rotation, translation, and scaling on a stereoscopic graph corresponding to a functional component in the three-dimensional logical view, to adjust the three-dimensional logical view, and the display module 130 displays an adjusted three-dimensional logical view.

Operation 1: Rotation

The user may perform, through a cursor, a rotation operation on the stereoscopic graph corresponding to the functional component in the three-dimensional logical view. In response to the rotation operation, the construction module 120 may rotate, according to a rotation direction of the cursor, the stereoscopic graph corresponding to the functional component. The user can fully view the functional component by rotating the stereoscopic graph.

Refer to FIG. 5B. When the cursor moves to the cuboid corresponding to the functional component 2, a rightward rotation arrow 501 and a leftward rotation arrow 502 are displayed. The user may click the rightward rotation arrow 501 or the leftward rotation arrow 502, so that the cuboid corresponding to the functional component 2 rotates to the right or rotates to the left. FIG. 5B uses an example of clicking to rotate to the left.

In a possible implementation, a stereoscopic graph corresponding to each functional component in the three-dimensional logical view is provided with a rotation operation area. When the cursor moves to the rotation operation area, the user triggers a movement direction and a movement angle in which the cursor moves in the rotation operation area to indicate a rotation direction and a rotation angle of a cuboid corresponding to the functional component. The movement angle of the cursor may be determined based on a fixed point on the cuboid and an included angle between a first straight line between the cursor and the fixed point before the movement and a second straight line between the cursor and the fixed point after the movement.

Refer to FIG. 5C. The cuboid corresponding to the functional component 2 may be set as the rotation operation area. The user triggers the cursor to move upward on the cuboid. Point A of the cuboid is used as a fixed point. A connection line between a cursor 503 and the point A before the movement and a connection line between a cursor 504 and the point A after the movement have an included angle of 30 degrees. In response to the rotation operation, the construction module 120 may rotate the cuboid counterclockwise by 30 degrees by using a central line of the cuboid as an axis.

In the foregoing description, that the user triggers cursor movement to perform the rotation operation is used as an example. It may be understood that, when a display that displays the three-dimensional logical view is a touchscreen, the user may also perform the rotation operation by using a gesture on the touchscreen (for example, the user taps a stereoscopic graph on the touchscreen and draws an arc on the touchscreen).

Operation 2: Movement

The user may perform, by using the cursor, a movement operation on the stereoscopic graph corresponding to the functional component in the three-dimensional logical view. In response to the movement operation, the construction module 120 may move, according to a movement direction and a movement position of the cursor, the stereoscopic graph corresponding to the functional component, and move the stereoscopic graph corresponding to the functional component to a position where the cursor stays. Movement in the stereoscopic graph in the three-dimensional logical view can change an affiliation relationship between functional components in the software architecture. Through the movement operation, the user can more conveniently change the affiliation relationship between the functional components. In addition, shielding may also exist between stereoscopic graphs in the three-dimensional view, and the user can also view the three-dimensional logical view more clearly by moving a position of the stereoscopic graph in the three-dimensional view.

Refer to FIG. 5D. When the cursor moves to the cuboid corresponding to the functional component 2, a rightward translation arrow 505 and a leftward translation arrow 506 are displayed. The user may click the rightward translation arrow 505 or the leftward translation arrow 506, so that the cuboid corresponding to the functional component 2 translates to the right or translates to the left. FIG. 5D uses an example of clicking the leftward translation arrow 506.

In a possible implementation, a stereoscopic graph corresponding to each functional component in the three-dimensional logical view is provided with a movement operation area. When the cursor moves to the movement operation area, the user triggers a movement direction and a movement position of the cursor in the movement operation area to indicate a movement direction and a movement position of the cuboid corresponding to the functional component 2.

Refer to FIG. 5E. An upper surface of the cuboid corresponding to the functional component 2 may be set as a movement operation area. The user triggers the cursor to move upward obliquely on the upper surface of the cuboid. For positions of a cursor 507 before the movement and a cursor 508 after the movement, refer to FIG. 5E. The construction module 120 may move the cuboid upward obliquely to a position where the cursor stays.

The foregoing content is described by using a manner in which the construction module 120 moves the stereoscopic graph corresponding to the functional component as an example. The user may not only perform a movement operation on the stereoscopic graph, but also move a connection line between the stereoscopic graphs, for example, may change a stereoscopic graph connected by the connection line. In response to the movement operation, the construction module 120 may change, based on a movement direction and a movement position of the cursor, the stereoscopic graph connected by the connection line, and change the stereoscopic graph connected by the connection line to the stereoscopic graph where the cursor locates. Movement of the connection line between the stereoscopic graphs in the three-dimensional logical view can change an association relationship between functional components in the software architecture. Through the movement operation, the user can more conveniently change the association relationship between the functional components.

Refer to FIG. 5F-1 and FIG. 5F-2. When the cursor moves to an endpoint P1 of a connection line L, the endpoint P1 is connected to the functional component 4. The user may drag the endpoint P1 of the connection line to change a stereoscopic graph connected to the endpoint P1 of the connection line L. After the dragging, a position of the endpoint P1 is P2, and P2 is located in the functional component 5. After the dragging, the connection line L connects the cuboid corresponding to the functional component 5 and the cuboid corresponding to the functional component 3.

In the foregoing description, that the user triggers cursor movement to perform the movement operation is used as an example. It may be understood that, when a display that displays the three-dimensional logical view is a touchscreen, the user may also perform the movement operation by using a gesture on the touchscreen (for example, the user taps a stereoscopic graph on the touchscreen and draws a straight line or an arc on the touchscreen).

Operation 3: Scaling-up or scaling-down operation (scaling operation for short)

The user may perform, by using the cursor, the scaling-up or scaling-down operation on the stereoscopic graph corresponding to the functional component in the three-dimensional logical view. In response to the scaling-up or scaling-down operation, the construction module 120 may scale up or scale down, based on a movement direction and a movement position of the cursor, the stereoscopic graph corresponding to the functional component. The user can view the three-dimensional logical view more clearly by scaling up or scaling down the stereoscopic graph, and the user can view the internal structure of the functional component conveniently by scaling up the stereoscopic graph.

In a possible implementation, a stereoscopic graph corresponding to each functional component in the three-dimensional logical view is provided with a scaling operation area. When the cursor moves to the scaling operation area, the user triggers a movement direction of the cursor in the scaling operation area to indicate scaling up or scaling down the stereoscopic graph corresponding to the functional component, and a movement position of the cursor in the scaling operation area may indicate a degree of scaling up or scaling down of the stereoscopic graph corresponding to the functional component. For example, each edge and each vertex of a stereoscopic graph (for example, a cuboid) in the three-dimensional view may be set as the scaling operation area, and movement of one edge of the stereoscopic graph (for example, the cuboid) in the three-dimensional view indicates that the scaling-down or scaling-up operation is scaling-up or scaling-down in one dimension of the stereoscopic graph. For example, scaling-up is performed in a length, width, or height direction of the cuboid. Movement of the cursor at each vertex indicates that the scaling-down or scaling-up operation is proportional scaling-down or scaling-up. In other words, each surface of the stereoscopic graph is scaled-down or scaled-up to the same extent.

Refer to FIG. 5G. Each edge and each vertex of the cuboid corresponding to the functional component may be set as the scaling operation area. The user triggers the cursor to move rightward on an edge B (an edge in a width direction of the cuboid) of the cuboid corresponding to the functional component 2. For positions of a cursor 509 before the movement and a cursor 510 after the movement, refer to FIG. 5F-1 and FIG. 5F-2. The construction module 120 may scale up the cuboid to increase a length of the cuboid, that is, increase the length of an edge C to scale up to a position where the cursor stays.

Refer to FIG. 5H. The user triggers the cursor to move upward obliquely on a vertex C of the cuboid. For positions of a cursor 511 before the movement and a cursor 512 after the movement, refer to FIG. 5G. The construction module 120 may scale up the cuboid proportionally to a position where the cursor stays.

In the foregoing description, that the user triggers cursor movement to perform the scaling operation is used as an example. It may be understood that, when a display that displays the three-dimensional logical view is a touchscreen, the user may also perform the movement operation by using a gesture on the touchscreen (for example, the user taps, by using two fingers, an area in which the stereoscopic graph is located on the touchscreen, where a movement direction of the two fingers on the touchscreen is relatively far away or close; and for another example, the user touches an edge or a vertex of the stereoscopic graph by using two fingers on the touchscreen, and draws a straight line or an arc on the touchscreen).

It can be seen from the foregoing that the software architecture displayed in the three-dimensional view shown in FIG. 5A is basically the same as the software architecture displayed in the two-dimensional view shown in FIG. 2A. Compared with FIG. 2A, FIG. 5A can further display an internal structure of each functional component. In the two-dimensional view, a two-dimensional graph (such as a linear box or an icon) is used to represent a functional component. The two-dimensional graph can only be moved or scaled. In the three-dimensional view, a three-dimensional graph (such as a cuboid) is used to represent a functional component. The three-dimensional graph can be rotated, moved, or scaled. It is clearly that, compared with the two-dimensional graph, the three-dimensional graph can display more details, display richer information, and have more flexible and intuitive display manners.

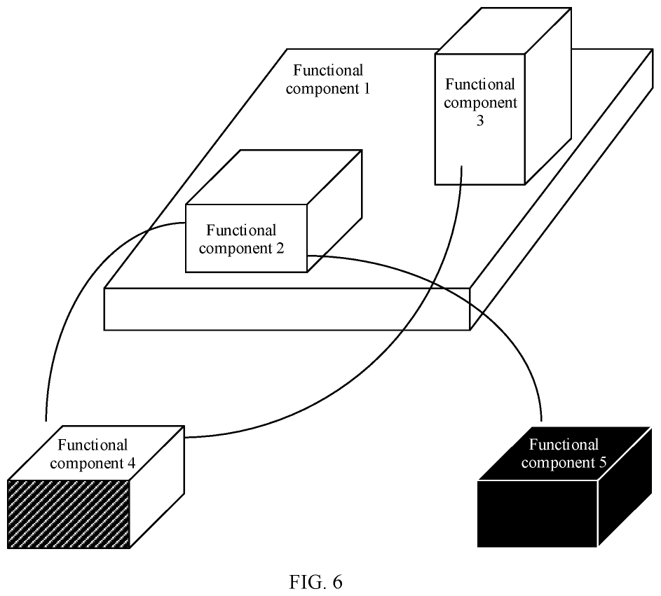

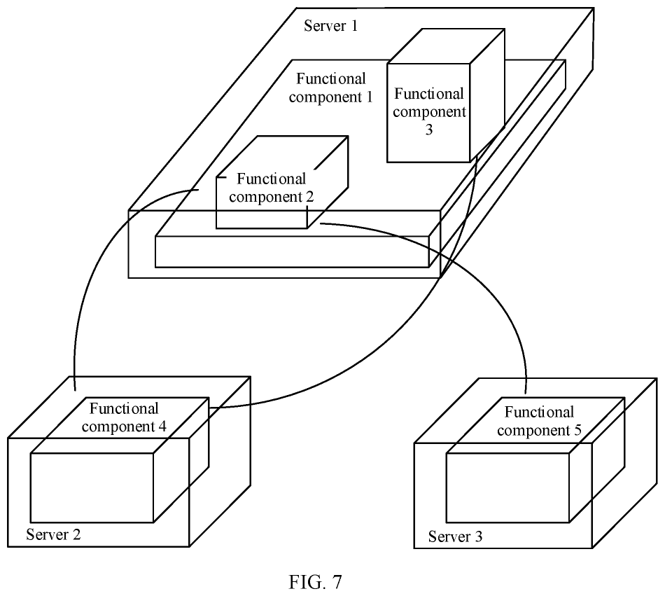

In addition, embodiments of this application further provide a three-dimensional running view and a three-dimensional deployment view. The following separately provides descriptions with reference to FIG. 6 and FIG. 7.

FIG. 6 shows a three-dimensional running view according to an embodiment of this application. Based on the three-dimensional logical view shown in FIG. 5A, a color of a cuboid corresponding to a functional component may be changed, and different colors are used to represent different running statuses of the functional component.

In FIG. 6, white indicates that the functional component runs normally, black stripes indicate that the functional component runs slowly because free disk space of the functional component reaches a threshold, and black indicates that the functional component is faulty. It can be directly learned from FIG. 6 that the functional component 2 and the functional component 3 run normally, the functional component 5 is faulty, and the functional component 4 runs slowly. Compared with the two-dimensional running view shown in FIG. 4, the three-dimensional running view can more vividly display a running status of a functional component.

It should be noted that a manner of representing a running status of a functional component by using a color in FIG. 6 is merely an example. In actual application, the color may not be limited to white, black stripes, or black, and the running status may not be limited to normal, slow, or faulty. For example, brightness of a same color may be used to represent running efficiency of the functional component. For example, green is used to represent normal running of the functional component. Deeper green indicates higher running efficiency of the functional component, and lighter green indicates lower running efficiency of the functional component. Any manner in which a running status of a functional component can be represented by using a color is applicable to this embodiment of this application. FIG. 6 shows only a running status of a functional component with a relatively large granularity. In a similar manner, a color of a stereoscopic graph (for example, a small cuboid) corresponding to a functional component included in the functional component is changed, and different running statuses of a functional component with a small granularity may be represented by using different colors.

FIG. 7 shows a three-dimensional deployment view according to an embodiment of this application. Based on the three-dimensional logical view shown in FIG. 5A, a three-dimensional graph that can indicate a deployment position of a functional component may be added, and the three-dimensional graph in which the functional component is located is used to indicate the position of the functional component.

In FIG. 7, a three-dimensional graph representing a server is added. The functional component 1, the functional component 2, and the functional component 3 are deployed in a server 1, the functional component 4 is deployed in a server 2, and the functional component 5 is deployed in a server 3. A deployment position of each functional component may be directly learned from FIG. 7. Compared with the two-dimensional deployment view shown in FIG. 4, the three-dimensional deployment view is easier to view.

The display module 130 may display the three-dimensional running view shown in FIG. 6 and the three-dimensional deployment view shown in FIG. 7 to the user. When viewing the three-dimensional running view or the three-dimensional deployment view, the user may also perform an operation such as rotation, translation, or scaling on the three-dimensional running view or the three-dimensional deployment view. In response to the operation of the user, the construction module 120 may rotate, translate, or scale a stereoscopic graph corresponding to a functional component in the three-dimensional running view or the three-dimensional deployment view. A manner in which the construction module 120 may rotate, translate, or scale the stereoscopic graph corresponding to the functional component in the three-dimensional running view or the three-dimensional deployment view is the same as a manner in which the construction module 120 may rotate, translate, or scale the stereoscopic graph corresponding to the functional component in the three-dimensional logical view. For details, refer to the foregoing content. Details are not described herein again.

It should be noted that the foregoing content describes the rotation, translation, and scaling operations. Embodiments of this application are not limited to the rotation, translation, and scaling operations. For example, the user may also trigger, by using a cursor or a gesture, the construction module 120 to delete a stereoscopic graph in the three-dimensional view (that is, delete a functional component corresponding to the stereoscopic graph in the software architecture), delete a three-dimensional graph in the three-dimensional view (that is, delete a functional component corresponding to the three-dimensional graph in the software architecture), and delete a connection line between stereoscopic graphs in the three-dimensional view (that is, delete an association relationship between functional components corresponding to the stereoscopic graphs in the software architecture). Alternatively, the construction module 120 may be triggered to add a stereoscopic graph in the three-dimensional view (that is, add a functional component corresponding to the stereoscopic graph in the software architecture), add a three-dimensional graph in the three-dimensional view (that is, add a functional component corresponding to the three-dimensional graph in the software architecture), and add a connection line between the stereoscopic graphs in the three-dimensional view (that is, add an association relationship between functional components corresponding to the stereoscopic graphs in the software architecture). Alternatively, the construction module 120 may be triggered to change a color of a stereoscopic graph in the three-dimensional view (that is, change a running status of a functional component corresponding to the stereoscopic graph in the software architecture), and change a color of a three-dimensional graph in the three-dimensional view (that is, change a running status of a functional component corresponding to the three-dimensional graph in the software architecture).

Manner 2: A plurality of instances in one functional component are the same.

In the three-dimensional view, a stereoscopic graph may be used to represent a functional component in the software architecture, and the stereoscopic graph may indicate a computing resource occupied by the functional component. A connection line between stereoscopic graphs can represent an association relationship between functional components. A three-dimensional graph included in the stereoscopic graph represents an instance included in the functional component.

There are many manners in which the stereoscopic graph indicates the computing resource occupied by the functional component, and two of the manners are listed below:

In a first manner, a cross-sectional area of a stereoscopic graph indicates a first computing resource (such as a processor, memory, and disk space) occupied by an instance in a functional component. A height of the stereoscopic graph may indicate a quantity of instances in the functional component.

Optionally, a cross-sectional area of a three-dimensional graph in the stereoscopic graph indicates a computing resource occupied by one instance in the functional component, and a height of the three-dimensional graph in the stereoscopic graph indicates another computing resource occupied by one instance in the functional component.

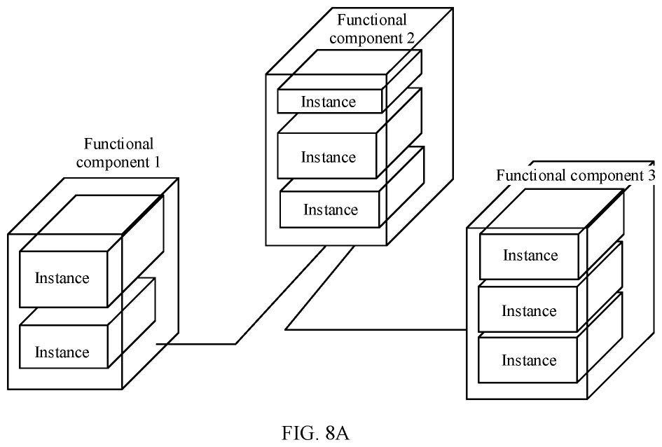

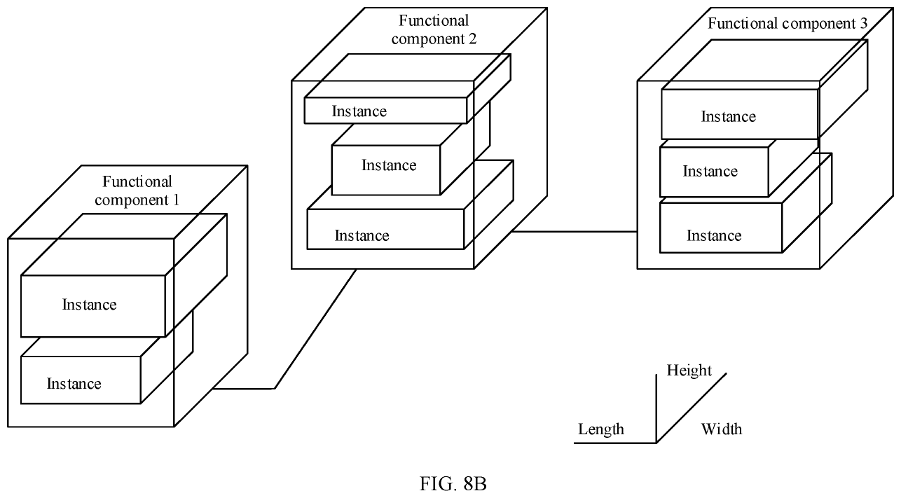

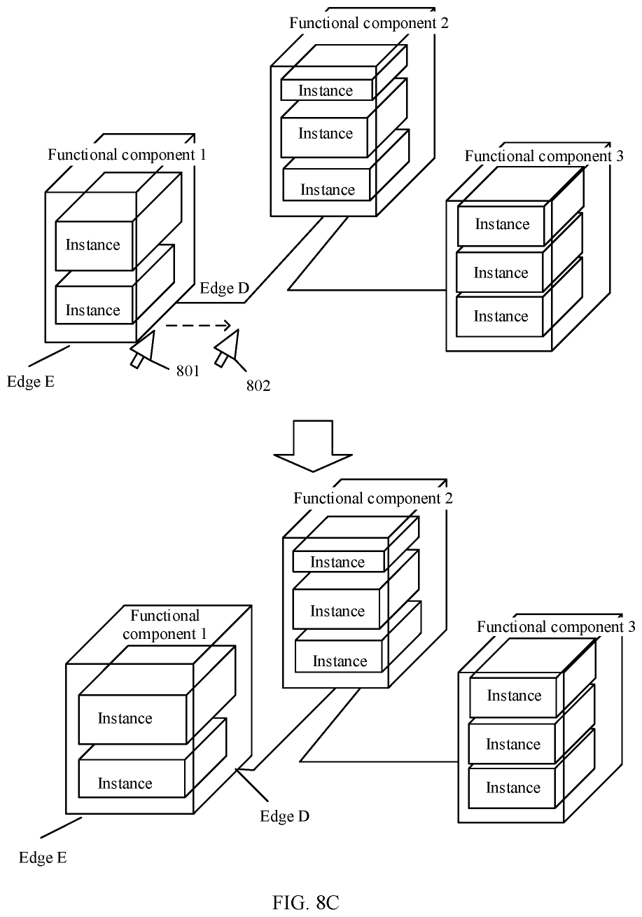

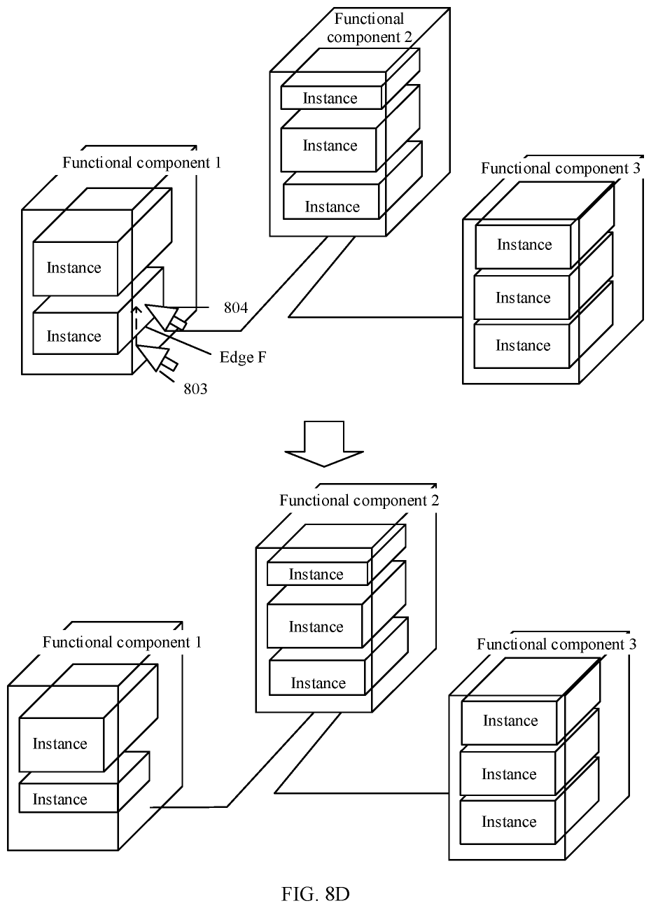

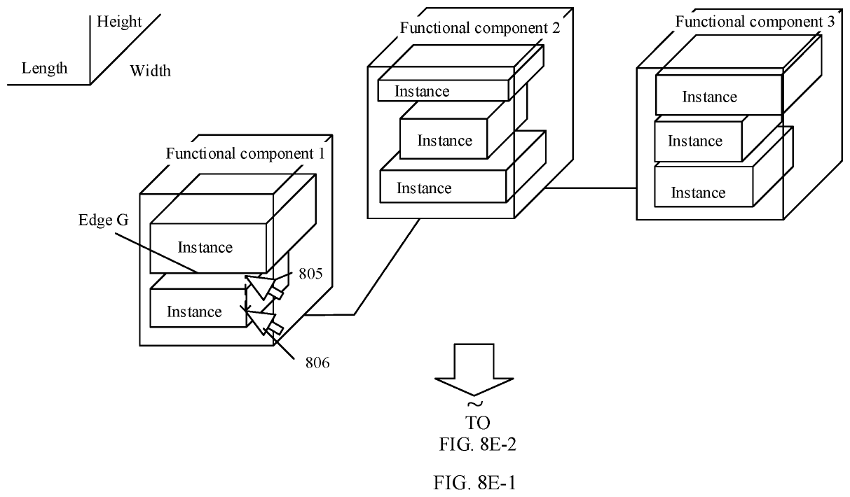

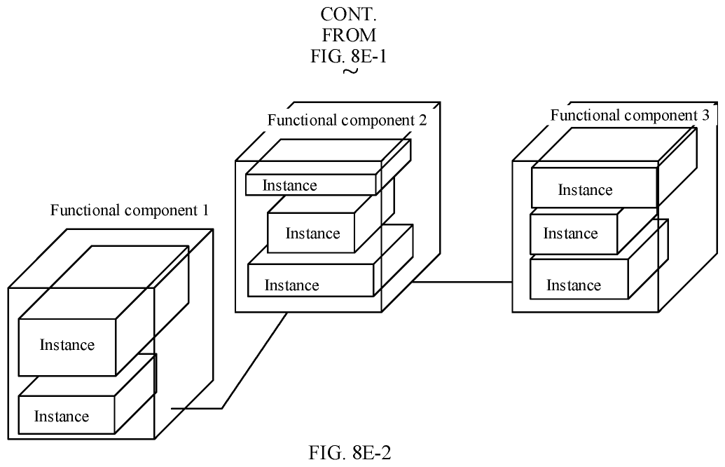

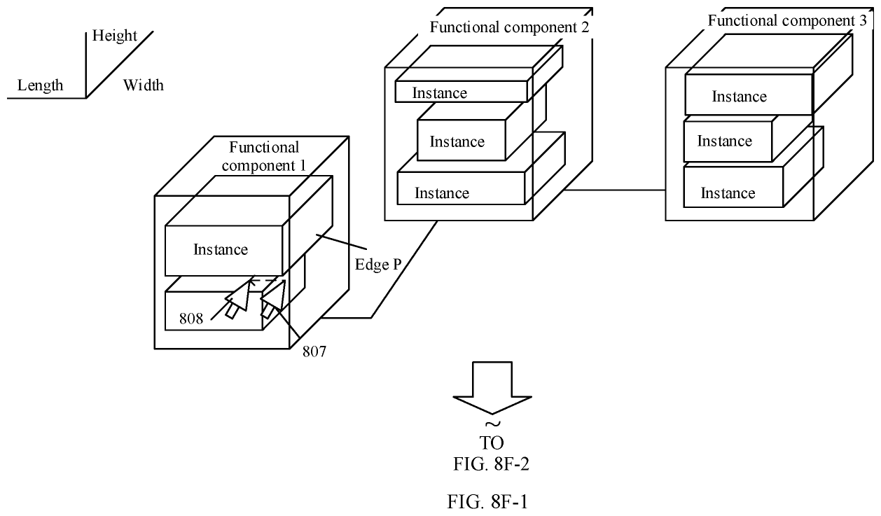

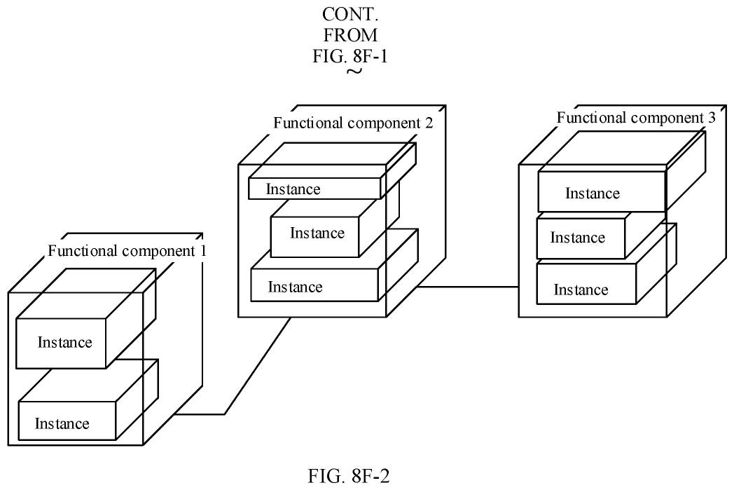

FIG. 8A is a three-dimensional view of a software architecture according to an embodiment of this application. The three-dimensional view includes three functional components: a functional component 1, a functional component 2, and a functional component 3. The functional component 1, the functional component 2, and the functional component 3 are all represented by cuboids. An area of an upper surface of the cuboid is used to indicate a quantity of processors in an instance in a functional component. It can be seen that, an area of an upper surface of the cuboid corresponding to the functional component 2 is greater than an area of an upper surface of the cuboid corresponding to the functional component 3, and a quantity of processors in an instance in the functional component 2 is greater than a quantity of processors in an instance in the functional component 3. Similarly, the quantity of processors in the instance in the functional component 3 is greater than the quantity of processors in the instance in the functional component 1. A height of the cuboid is used to indicate a quantity of instances in the functional component. It can be seen that a height of the cuboid corresponding to the functional component 2 is greater than a height of the cuboid corresponding to the functional component 1, and a quantity of instances in the functional component 2 is greater than a quantity of instances in the functional component 1. Similarly, a quantity of instances in the functional component 3 is greater than the quantity of instances in the functional component 1.

The cuboid corresponding to the functional component 1 includes two small cuboids whose upper surface is the same as that of the cuboid and height is different from that of the cuboid. The cuboid corresponding to the functional component 2 includes three small cuboids whose upper surface is the same as that of the cuboid and height is different from that of the cuboid. The cuboid corresponding to the functional component 3 includes three small cuboids whose upper surface is the same as that of the cuboid and height is the same as that of the cuboid.

Each small cuboid is used to represent an instance in the functional component. An upper surface of the small cuboid is used to represent a processor in the instance. A larger area of the upper surface indicates a larger quantity of processors in the instance. A height of the small cuboid is used to represent memory in the instance. A larger height of the small cuboid indicates larger memory of the processor in the instance. It can be seen that, in FIG. 8A, instances in a same functional component have a same quantity of processors, the functional component 1 includes two instances having different memory sizes, the functional component 2 includes three instances having different memory sizes, and the functional component 3 includes three instances having a same memory size. There is a connection line between the cuboid representing the functional component 2 and cuboids representing the functional component 1 and the functional component 3, indicating that the functional component 2 is associated with the functional component 1 and the functional component 3.

In FIG. 8A, a quantity of processors in instances in the same functional component is the same. If the quantity of processors in the instances in the same functional component is different, a cuboid corresponding to the functional component may also be divided into small cuboids with different upper surface areas. The different upper surface areas of the small cuboids indicate that the quantity of processors in the instances in the functional component is different. The upper surface area of the cuboid corresponding to the functional component may indicate a maximum quantity of processors occupied by the instances in the functional component.

In a second type, edges in different directions of a stereoscopic graph in a three-dimensional view separately indicate different computing resources. For example, a length, a width, and a height of the stereoscopic graph separately indicate a computing resource.

Specifically, for a three-dimensional graph in the stereoscopic graph, a length, a width, and a height of the three-dimensional graph separately indicate a computing resource occupied by an instance in the functional component.

FIG. 8B is a three-dimensional view of another software architecture according to an embodiment of this application. The three-dimensional view includes three functional components: a functional component 1, a functional component 2, and a functional component 3. The functional component 1, the functional component 2, and the functional component 3 are all represented by cuboids. A width of a cuboid indicates a processor occupied in a functional component, a length of the cuboid indicates memory occupied in the functional component, and a height of the cuboid indicates disk space occupied in the functional component.

The cuboid corresponding to the functional component may be further divided into a plurality of small cuboids. Each small cuboid represents an instance. A width of the small cuboid represents a quantity of processors in the instance. A larger width of the small cuboid indicates a larger quantity of processors in the instance. A length of the small cuboid represents memory of the instance. A larger length of the small cuboid indicates larger memory space in the instance. A height of the small cuboid represents disk space of the instance. A larger height of the small cuboid indicates larger disk space of the instance.

The cuboid corresponding to the functional component 1 includes two small cuboids. The cuboid corresponding to the functional component 2 and the cuboid corresponding to the functional component 3 include three small cuboids.

The three-dimensional views shown in FIG. 8A and FIG. 8B mainly display an association relationship and an inclusion relationship between functional components in software, and may be considered as a three-dimensional logical view of the software architecture.

The display module 130 may display the three-dimensional logical view shown in FIG. 8A or FIG. 8B to a user. When viewing the three-dimensional logical view, the user may further perform some operations on the three-dimensional logical view. The operations include but are not limited to: rotation, movement, and scaling. In response to an operation of the user, the construction module 120 may perform operations such as rotation, translation, and scaling on a stereoscopic graph corresponding to a functional component in the three-dimensional logical view. For a manner in which the construction module 120 may rotate or move the stereoscopic graph corresponding to the functional component in the three-dimensional logical view, refer to the foregoing content. Details are not described herein again.

Because the three-dimensional logical view shown in FIG. 8A or FIG. 8B shows a resource in a functional component, scaling-up or scaling-down of a cuboid corresponding to the functional component indicates that the resource in the functional component changes. The following describes the scaling operation.

The user may perform, by using a cursor, a scaling-up or scaling-down operation on the stereoscopic graph corresponding to the functional component in the three-dimensional logical view. In response to the scaling-up or scaling-down operation, the construction module 120 may scale up or scale down, based on a movement direction and a movement position of the cursor, the stereoscopic graph corresponding to the functional component, and change a computing resource occupied by the functional component. The user may further perform, by using the cursor, the scaling-up or scaling-down operation on a three-dimensional graph in the stereoscopic graph corresponding to the functional component. In response to the scaling-up or scaling-down operation, the construction module 120 may scale up or scale down, based on the movement direction and the movement position of the cursor, the three-dimensional graph in the stereoscopic graph corresponding to the functional component. By scaling up or scaling down the three-dimensional graph, the user can view the three-dimensional logical view more clearly, and may further change the computing resource occupied by the instance in the functional component.

In a possible implementation, a stereoscopic graph corresponding to each functional component in the three-dimensional logical view and a three-dimensional graph included in the stereoscopic graph are provided with a scaling operation area. When the cursor moves to the scaling operation area, the user triggers a movement direction of the cursor in the scaling operation area to indicate scaling up or scaling down the stereoscopic graph corresponding to the functional component or the three-dimensional graph in the stereoscopic graph, and a movement position of the cursor in the scaling operation area may indicate a degree of scaling up or scaling down of a cuboid corresponding to the functional component or the three-dimensional graph in the stereoscopic graph. For example, each edge and each vertex of the stereoscopic graph or the three-dimensional graph in the three-dimensional view may be set as the scaling operation area. A movement of an edge of the stereoscopic graph or the three-dimensional graph (for example, the cuboid) in the three-dimensional view indicates that the scaling-down or scaling-up operation is scaling up or scaling down in a dimension of the stereoscopic graph or the three-dimensional graph, and indicates that a computing resource occupied by the functional component represented by the stereoscopic graph changes, or a computing resource occupied by the three-dimensional graph changes. For example, scaling-up is performed in a length, width, or height direction of the cuboid. Movement of the cursor at each vertex indicates that the scaling-down or scaling-up operation is proportional scaling-down or scaling-up. In other words, each surface of the stereoscopic graph is scaled-down or scaled-up to the same extent, indicating that all computing resources occupied by the functional component represented by the stereoscopic graph change, or all computing resources occupied by the three-dimensional graph change.

For the three-dimensional logical view shown in FIG. 8A, edges and vertices of the cuboid corresponding to the functional component are set as the scaling operation area. Refer to FIG. 8C. If a quantity of processors in each instance in the functional component 1 needs to be increased, the user may trigger the cursor to move rightward on an edge D (an edge in a width direction of the cuboid) of the cuboid corresponding to the functional component 1. For positions of a cursor 801 before the movement and a cursor 802 after the movement, refer to FIG. 8C. The construction module 120 may scale up the cuboid to increase a length of the cuboid, that is, increase a length of an edge E, scale up the cuboid to a position where the cursor stays, and increase an area of an upper surface of the cuboid corresponding to the functional component.

For the three-dimensional logical view shown in FIG. 8A, edges and vertices of the cuboid corresponding to the functional component are set as the scaling operation area. Refer to FIG. 8D. If memory space of an instance in the functional component 1 is reduced, the user may trigger the cursor to move upward on an edge F (an edge in a length direction of a small cuboid) of a small cuboid in the cuboid corresponding to the functional component 1. For positions of a cursor 803 before the movement and a cursor 804 after the movement, refer to FIG. 8D. The construction module 120 may move a lower surface of the small cuboid upward, scale down the small cuboid to a position where the cursor stays, and reduce a height of the small cuboid in the cuboid corresponding to the functional component.

For the three-dimensional logical view shown in FIG. 8B, edges and vertices of the cuboid corresponding to the functional component are set as the scaling operation area. Refer to FIG. 8E-1 and FIG. 8E-2. If a quantity of processors in an instance in the functional component 1 needs to be increased, the user may trigger the cursor to move downward on an edge G (an edge in a length direction of a small cuboid) of a small cuboid corresponding to the instance. For positions of a cursor 805 before the movement and a cursor 806 after the movement, refer to FIG. 8E-1 and FIG. 8E-2. The construction module 120 may scale up the small cuboid in a width direction, increase a width of the small cuboid, and scale up the cuboid to a position where the cursor stays.

For the three-dimensional logical view shown in FIG. 8B, edges and vertices of the cuboid corresponding to the functional component are set as the scaling operation area. Refer to FIG. 8F-1 and FIG. 8F-2. If memory space of an instance in the functional component 1 is reduced, the user may trigger the cursor to move leftward on an edge P (an edge in a width direction of a small cuboid) of a small cuboid corresponding to the instance. For positions of a cursor 807 before the movement and a cursor 808 after the movement, refer to FIG. 8F-1 and FIG. 8F-2. The construction module 120 may scale down the small cuboid in a length direction, reduce a length of the cuboid, and scale down the cuboid to a position where the cursor stays.

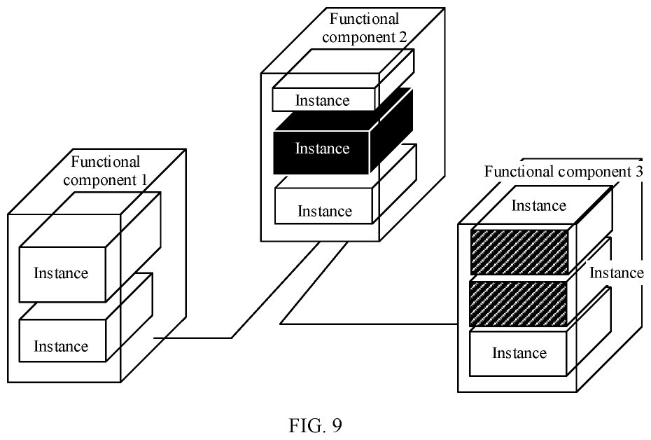

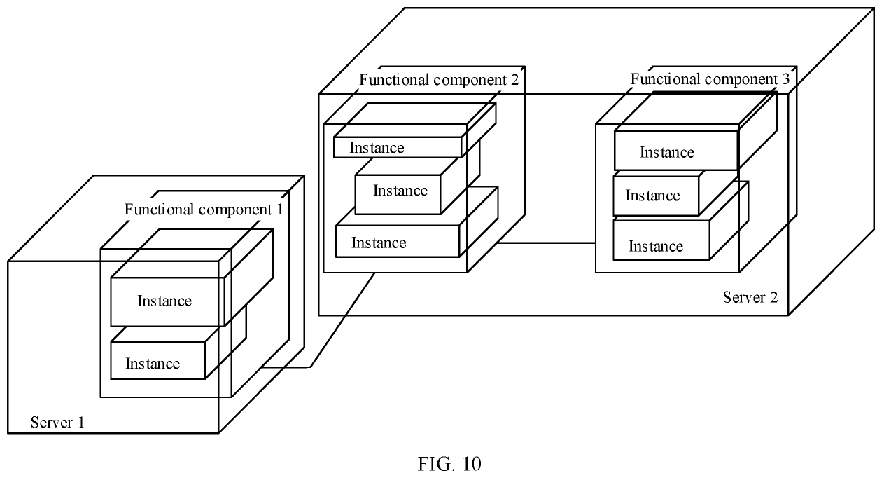

Embodiments of this application further provide a three-dimensional running view and a three-dimensional deployment view. The following separately provides descriptions with reference to FIG. 9 and FIG. 10.

FIG. 9 shows a three-dimensional running view according to an embodiment of this application. Based on the three-dimensional logical view shown in FIG. 8A, a color of a cuboid corresponding to a functional component or a small cuboid corresponding to an instance may be changed, and different colors are used to represent different running statuses of the functional component or different running statuses of the instance.

In FIG. 9, white indicates that the functional component runs normally, black stripes indicate that the functional component runs slowly because free disk space of the functional component reaches a threshold, and black indicates that the functional component is faulty. It can be directly learned from FIG. 9 that instances in the functional component 1 run normally; one instance in the functional component 2 is faulty, and two instances run normally; and two instances in the functional component 3 run slowly, and one instance runs normally.

It should be noted that a manner of representing a running status of a functional component by using a color in FIG. 9 is merely an example. In actual application, the color may not be limited to white, black stripes, or black, and the running status may not be limited to normal, slow, or faulty. For example, brightness of a same color may be used to represent running efficiency of a functional component.

FIG. 10 shows a three-dimensional deployment view according to an embodiment of this application. Based on the three-dimensional logical view shown in FIG. 10, a three-dimensional graph that can indicate a deployment position of a functional component may be added, and the three-dimensional graph in which the functional component is located is used to indicate the position of the functional component.

In FIG. 10, a three-dimensional graph representing a server is added. The functional component 1 is deployed in a server 1, and the functional component 2 and the functional component 3 are deployed in a server 2.

The display module 130 may display the three-dimensional running view shown in FIG. 9 and the three-dimensional deployment view shown in FIG. 10 to the user. When viewing the three-dimensional running view or the three-dimensional deployment view, the user may also perform an operation such as rotation, movement, or scaling on the three-dimensional running view or the three-dimensional deployment view. In response to the operation of the user, the construction module 120 may rotate, move, or scale a stereoscopic graph corresponding to a functional component in the three-dimensional running view or the three-dimensional deployment view. A manner in which the construction module 120 may rotate, move, or scale the stereoscopic graph corresponding to the functional component in the three-dimensional running view or the three-dimensional deployment view is the same as a manner in which the construction module 120 may rotate, move, or scale the stereoscopic graph corresponding to the functional component in the three-dimensional logical view. For details, refer to the foregoing content. Details are not described herein again.

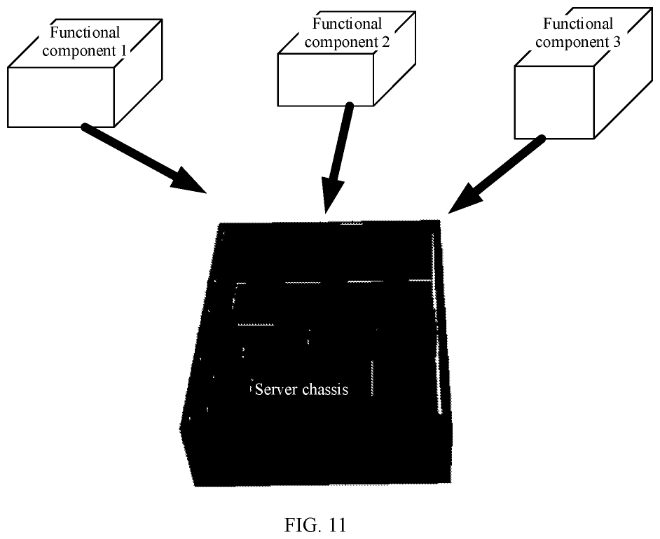

It should be noted that, in addition to the logical view, the running view, and the deployment view, the three-dimensional view may further provide a mapping view of an entity apparatus and a functional component. When there is a correspondence between the functional component in the software architecture and the entity apparatus, it means that in actual application, a function of the functional component may be implemented by using the entity apparatus. The entity apparatus and the functional component having a correspondence may be drawn in the mapping view, and a connection between the entity apparatus and the functional component is used to represent the correspondence between the functional component and the entity apparatus. FIG. 11 shows a three-dimensional mapping view according to an embodiment of this application. A three-dimensional structure of a server chassis is drawn in the three-dimensional mapping view. There is a correspondence between the functional component 1, the functional component 2, and the functional component 3 and the server chassis. In FIG. 11, an arrow between the functional component and the server chassis is used to indicate the correspondence.

The foregoing content describes a method for displaying the software architecture by using the two-dimensional view and the three-dimensional view, and a method for changing the three-dimensional view. The following describes a method for constructing the two-dimensional view and the three-dimensional view. The method for constructing the two-dimensional view and the three-dimensional view includes two aspects: one is a method for preliminarily constructing a view of the software architecture, and the other is a method for updating the view of the software architecture. The method for updating the view of the software architecture may be classified into an update method based on update information, and a method for updating another view based on an updated view.

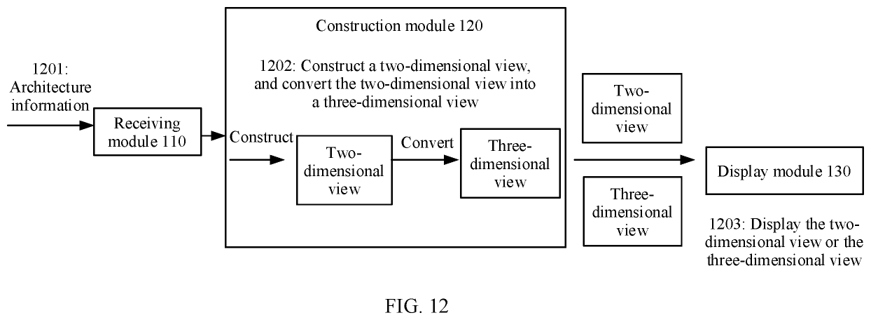

The following describes, with reference to FIG. 12, a method for preliminarily constructing a view of a software architecture according to an embodiment of this application. As shown in FIG. 12, the method includes the following steps.

Step 1201: The receiving module 110 receives architecture information of software, where the architecture information may include a name of a functional component in the software and an association relationship between functional components.

The architecture information may be sent by another device to the receiving module 110. For example, the another device may send a view display request to the receiving module 110, where the view display request is used to request a view of the software, and the view display request carries the architecture information of the software.

Alternatively, the architecture information may be generated when triggered by a user. For example, the user may enter the architecture information of the software on an interface, and the receiving module 110 receives the architecture information after detecting an input operation of the user.

In addition to the functional components included in the software and the association relationship between the functional components, the architecture information may further include other information. Information included in the architecture information is related to information that needs to be displayed in the view.

For example, if only a logical view of the software needs to be displayed subsequently, the architecture information may include a name of each functional component in the software and an association relationship between the functional components. If there is an inclusion relationship between the functional components in the software, the architecture information may further include the inclusion relationship between the functional components. Optionally, structure information of the functional component may be further included. The structure information indicates an internal structure of the functional component, for example, a quantity of instances, a quantity of instances, a quantity of processors, and a size of disk space that can be occupied in the functional component.

If only a running view of the software needs to be displayed subsequently, the architecture information may include a name of each functional component in the software, an association relationship between the functional components, and a running status of each functional component. If there is an inclusion relationship between the functional components in the software, the architecture information may further include the inclusion relationship between the functional components. The architecture information may further include the structure information of the functional component.

If only a deployment view of the software needs to be displayed subsequently, the architecture information may include a name of each functional component in the software, an association relationship between the functional components, and position information of each functional component. If there is an inclusion relationship between the functional components in the software, the architecture information may further include the inclusion relationship between the functional components.

If a logical view, a running view, and a deployment view of the software needs to be displayed subsequently, the architecture information may include a name of each functional component, an association relationship between the functional components, a running status of each functional component, and position information of each functional component. If there is an inclusion relationship between the functional components in the software, the architecture information may further include the inclusion relationship between the functional components.

Step 1202: The construction module 120 constructs a two-dimensional view based on the architecture information, and converts the two-dimensional view into a three-dimensional view.

The construction module 120 obtains the architecture information, and may first construct the two-dimensional view based on degrees of difficulty of view construction, and then convert the two-dimensional view into the three-dimensional view. Alternatively, the construction module 120 may first construct the three-dimensional view based on degrees of richness of view display information, and then convert the three-dimensional view into the two-dimensional view.

The following describes construction of the two-dimensional view and the three-dimensional view, and a manner of conversion between the two views.

(1) Construct the two-dimensional view.

The construction module 120 may read the architecture information; determine a quantity of functional components included in the software and a name of each functional component; construct a same quantity of two-dimensional graphs, where each two-dimensional graph represents a functional component (that is, each functional component corresponds to a two-dimensional graph); and add a name of a corresponding functional component to each two-dimensional graph.

The construction module 120 may further determine the association relationship between the functional components by using the architecture information, and add a connection line between two-dimensional graphs corresponding to the functional components that have the association relationship.

If the architecture information further includes the running status of each functional component, the construction module 120 may add, to a two-dimensional graph corresponding to each functional component, text information that describes the running status of the functional component.

If the architecture information further includes the position information of each functional component, the construction module 120 may add, to a two-dimensional graph corresponding to each functional component, text information that describes the position information of the functional component.

(2) Construct the three-dimensional view.

The construction module 120 may read the architecture information; determine a quantity of functional components included in the software and a name of each functional component; construct a same quantity of stereoscopic graphs, where each stereoscopic graph represents a functional component (that is, each functional component corresponds to a stereoscopic graph); and add a name of a corresponding functional component to each stereoscopic graph.

The construction module 120 may further determine the association relationship between the functional components by using the architecture information, and add a connection line between stereoscopic graphs corresponding to the functional components that have the association relationship.

If the architecture information may include the structure information of the functional component, the construction module 120 may divide, based on the structure information of the functional component, a stereoscopic graph corresponding to the functional component, and use space obtained through division to represent a structure of the functional component. For example, the functional component includes three instances, and the construction module 120 may divide the stereoscopic graph corresponding to the functional component into three small stereoscopic graphs, for example, each small stereoscopic graph represents an instance.

If the architecture information further includes the running status of each functional component, the construction module 120 may change a color of a stereoscopic graph corresponding to each functional component, and change the color of the functional component to a color corresponding to the running status of the functional component.

If the architecture information further includes the position information of each functional component, the construction module 120 may add a three-dimensional graph describing a position, place three-dimensional graphs corresponding to functional components with same position information in a same three-dimensional graph, and may further set a name of the three-dimensional graph based on the position information of the functional component.

(3) Conversion between the two-dimensional view and the three-dimensional view.

After constructing the two-dimensional view, the construction module 120 may convert the two-dimensional graph in the two-dimensional view into a stereoscopic graph. If the two-dimensional view includes text information used to describe a running status of a functional component, the construction module 120 may change, based on the text information, a color of the stereoscopic graph corresponding to the functional component to a color corresponding to the running status of the functional component. If the two-dimensional view includes text information used to describe position information of a functional component, the construction module 120 may add a three-dimensional graph based on the text information, and place stereoscopic graphs corresponding to functional components with the same position information in a same three-dimensional graph. In this way, conversion from the two-dimensional view to the three-dimensional view is completed.

It should be noted that, when the architecture information further includes the structure information of the functional component, because the structure information of the functional component is not displayed in the two-dimensional view, the construction module 120 may read the structure information of the functional component in the architecture information, and divide, based on the structure information of the functional component, a stereoscopic graph corresponding to the functional component, and use space (such as the three-dimensional graph) obtained through division to represent a structure of the functional component.

(4) Conversion between the three-dimensional view and the two-dimensional view.

After constructing the three-dimensional view, the construction module 120 may convert a stereoscopic graph in the three-dimensional view into a two-dimensional graph. If stereoscopic graphs corresponding to functional components in the three-dimensional view have different colors, the construction module 120 may determine, based on a color of a stereoscopic graph corresponding to a functional component, a running status of the functional component, and add text information used to describe the running status to the two-dimensional graph. If the three-dimensional view includes a three-dimensional graph used to describe a position of a functional component, the construction module 120 may delete the three-dimensional graph, and add text information to a two-dimensional graph converted from the stereoscopic graph included in the three-dimensional graph, where the added text information may be a name of the three-dimensional graph. In this way, conversion from the three-dimensional view to the two-dimensional view is completed.

Step 1203: The display module 130 displays the two-dimensional view or the three-dimensional view when triggered by the user.

After constructing the two-dimensional view and the three-dimensional view, the construction module 120 may display the two-dimensional view or the three-dimensional view according to triggering of the user.

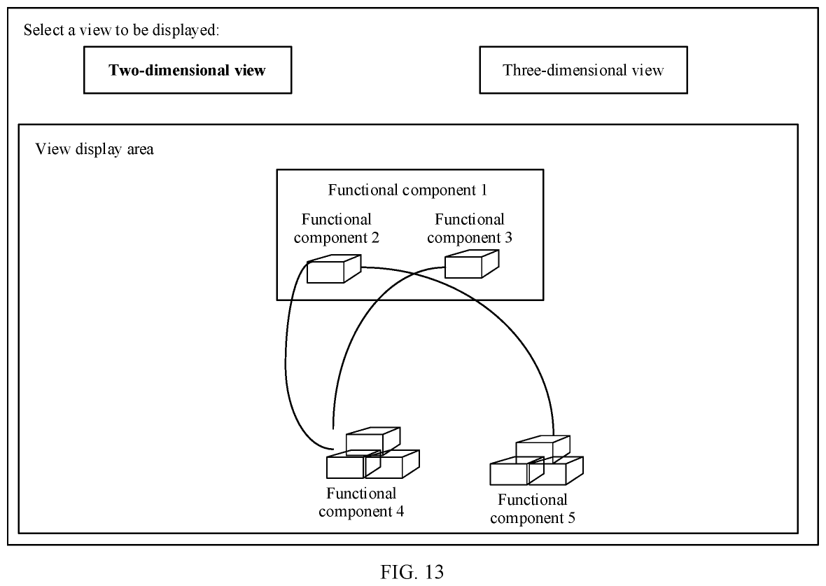

For example, the display module 130 may provide display options of a two-dimensional view and a three-dimensional view for the user. As shown in an interface shown in FIG. 13, the user may select the two-dimensional view or the three-dimensional view based on a requirement of the user. After receiving the triggering of the user, the display module 130 may display, in a display area, the view selected by the user.

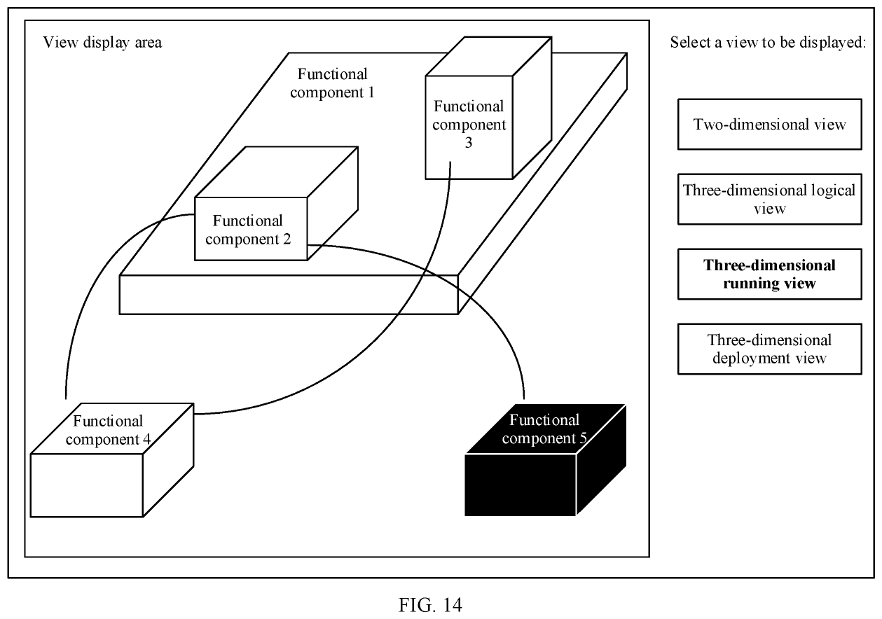

In a possible implementation, the display module 130 may provide a plurality of display options for the user. For example, the display module 130 may provide the user with a display interface shown in FIG. 14. The interface provides a two-dimensional view, a three-dimensional logical view, a three-dimensional deployment view, and a three-dimensional running view. In this way, the user can view the software architecture in a targeted manner.

The user can select a view based on a requirement. After the user clicks a corresponding option, the selected view may be displayed in a view display area.

Generally, the software architecture can be changed. For example, when the architecture information of the software is updated (for example, an operation such as optimization or reassembling is performed on the software), a quantity of functional components included in the software architecture, an association relationship between the functional components, and the like change. To accurately display the software architecture, when the software architecture changes, the view of the software architecture may also be updated to some extent. For another example, when either of the three-dimensional view or the two-dimensional view is updated, the other of the three-dimensional view and the two-dimensional view also needs to be updated.

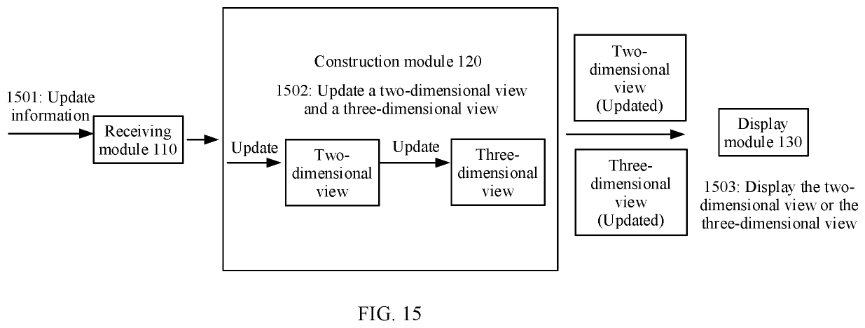

The following describes, with reference to FIG. 15, a method for updating a view of a software architecture according to an embodiment of this application. As shown in FIG. 15, the method includes the following steps.

Step 1501: The receiving module 110 receives update information of a software architecture, where the update information includes a changed functional component in the software architecture, and optionally, the update information may further include a changed association relationship.

Information carried in the update information is related to a change of software. The following lists several types of information that may be included in the update information.

1. When a functional component in the software architecture changes, the update information may include a name of the changed functional component and a change manner.

In this embodiment of this application, a manner of changing a functional component includes but is not limited to deleting the functional component and adding the functional component. When the functional component is deleted, the update information may include a name of the deleted functional component. When the functional component is added, the update information may include a name of the added functional component. Optionally, the update information may further include an association relationship between the added functional component and another functional component.

2. When a running status of a functional component in the software architecture changes, the update information may include a name of the changed functional component and a running status of the functional component after the change.

3. When a deployment position of a functional component in the software architecture changes, the update information may include a name of the changed functional component and position information of the functional component after the change.

4. When a structure of a functional component in the software architecture changes, the update information may include a name of the changed functional component and structure information of the functional component after the change.

For example, a computing resource occupied by the functional component may be changed, for example, instances are increased or reduced, or disk space, a processor, or memory that can be occupied by an instance is increased or reduced.

A manner in which the receiving module 110 receives the update information is the same as a manner in which the receiving module 110 receives the architecture information. For details, refer to the foregoing content. Details are not described herein again.

In a possible implementation, the update information may also be generated when the construction module 120 detects that a user performs some operations on a two-dimensional view or a three-dimensional view, for example, the user performs a movement or scaling operation on the two-dimensional view or the three-dimensional view. After detecting the operation, the construction module 120 generates architecture information of the software and generates the update information of the software.

Step 1502: The construction module 120 updates the two-dimensional view and the three-dimensional view based on the update information. When the construction module 120 updates the two-dimensional view and the three-dimensional view based on the update information, the construction module 120 may first update the two-dimensional view, and then update the three-dimensional view by using an updated two-dimensional view. Alternatively, the construction module 120 may first update the three-dimensional view, and then update the two-dimensional view by using an updated three-dimensional view. Alternatively, the construction module 120 may separately update the two-dimensional view and the three-dimensional view.

Manners of updating the two-dimensional view and the three-dimensional view by the construction module 120 vary with information included in the update information, and are separately described in the following.

The information carried in the update information is related to the change of the software. The following lists several types of information that may be included in the update information.

1. The update information includes a name of a changed functional component and a change manner.

For the two-dimensional view, when the change is to delete a functional component, the construction module 120 may delete, from the two-dimensional view, a two-dimensional graph corresponding to the functional component, and may further delete a connection line between the two-dimensional graph corresponding to the functional component and a two-dimensional graph corresponding to another functional component.

For the three-dimensional view, when the change is to delete a functional component, the construction module 120 may delete, from the three-dimensional view, a stereoscopic graph corresponding to the functional component, and may further delete a connection line between the stereoscopic graph corresponding to the functional component and a stereoscopic graph corresponding to another functional component.

For the two-dimensional view, when the change is to add a functional component, the construction module 120 may add, to the two-dimensional view, a two-dimensional graph corresponding to the functional component, and may further add a connection line between the two-dimensional graph corresponding to the functional component and a two-dimensional graph corresponding to another functional component.

For the three-dimensional view, when the change is to add a functional component, the construction module 120 may add, to the three-dimensional view, a stereoscopic graph corresponding to the functional component, and may further add a connection line between the stereoscopic graph corresponding to the functional component and a stereoscopic graph corresponding to another functional component.

For the three-dimensional view, when the change is to adjust a computing resource occupied by a functional component or a computing resource occupied by an instance in a functional component, the construction module 120 may adjust, in the three-dimensional view, a size of a stereoscopic graph corresponding to the functional component (for example, adjust a cross-sectional area, a height, a length, and a width of the stereoscopic graph), and a size of a three-dimensional graph corresponding to the instance (for example, adjust a cross-sectional area, a height, a length, and a width of the three-dimensional graph).

2. The update information includes a name of a changed functional component and a running status of the functional component after the change.

For the two-dimensional view, the construction module 120 may update, in the two-dimensional view based on the running status of the functional component after the change, text information that describes the running status of the functional component.

For the three-dimensional view, the construction module 120 may update, in the three-dimensional view based on the running status of the functional component after the change, a color of the stereoscopic graph corresponding to the functional component.

3. The update information includes a name of a changed functional component and position information of the functional component after the change.

For the two-dimensional view, the construction module 120 may update, in the two-dimensional view based on the position information of the functional component after the change, a text that describes the position information of the functional component.

For the three-dimensional view, the construction module 120 may update, in the three-dimensional view based on the position information of the functional component after the change, a name of a three-dimensional graph in which the stereoscopic graph corresponding to the functional component is located.

The foregoing content describes manners of separately updating the three-dimensional view and the two-dimensional view. The following describes manners in which the construction module 120 updates the three-dimensional view by using the updated two-dimensional view and updates the two-dimensional view by using the updated three-dimensional view.

(1) The construction module 120 updates the three-dimensional view by using the updated two-dimensional view.

1. The functional components in the updated two-dimensional view are changed. For example, a functional component is deleted or added.

The construction module 120 determines the functional component deleted from the updated two-dimensional view, deletes a stereoscopic graph corresponding to the same functional component from the three-dimensional view, and may further delete a connection line between the stereoscopic graph corresponding to the functional component and a stereoscopic graph corresponding to another functional component.

The construction module 120 determines the functional component added to the updated two-dimensional view, adds a stereoscopic graph corresponding to the same functional component to the three-dimensional view, and may further add, based on an association relationship between the functional component and another functional component recorded in the two-dimensional view, a connection line between the stereoscopic graph corresponding to the functional component and a stereoscopic graph corresponding to another functional component to the three-dimensional view.

2. The running status of the functional component in the updated two-dimensional view is changed.

The construction module 120 determines changed text information that describes and updates the running status of the functional component in the updated two-dimensional view, and updates, based on the text information, a color of a stereoscopic graph corresponding to the same functional component in the three-dimensional view.

3. The position information of the functional component in the updated two-dimensional view is changed.

The construction module 120 determines changed text information that describes the position information of the functional component in the updated two-dimensional view, and updates, based on the text information, a name of a three-dimensional graph in which a stereoscopic graph corresponding to the functional component is located in the three-dimensional view.

(2) The construction module 120 updates the two-dimensional view by using the updated three-dimensional view.

1. The functional components in the updated three-dimensional view are changed. For example, a functional component is deleted or added.

The construction module 120 determines the functional component deleted from the updated three-dimensional view, deletes a stereoscopic graph corresponding to the same functional component from the two-dimensional view, and may further delete a connection line between the two-dimensional graph corresponding to the functional component and a two-dimensional graph corresponding to another functional component.

The construction module 120 determines the functional component added to the updated three-dimensional view, adds a two-dimensional graph corresponding to the same functional component to the two-dimensional view, and may further add, based on an association relationship between the functional component and another functional component recorded in the three-dimensional view, a connection line between the two-dimensional graph corresponding to the functional component and a two-dimensional graph corresponding to another functional component to the two-dimensional view.

2. The running status of the functional component in the updated three-dimensional view is changed.

The construction module 120 determines a color of a stereoscopic graph corresponding to the changed functional component in the updated three-dimensional view, and modifies, based on the color, the text information that describes the running status of the functional component in the two-dimensional view.

3. The position information of the functional component in the updated three-dimensional view is changed.

The construction module 120 determines a name of a three-dimensional graph in which the stereoscopic graph corresponding to the changed functional component in the updated three-dimensional view is located, and modifies, based on the name of the three-dimensional graph, the text that describes the position information of the functional component in the two-dimensional view.

It should be noted that, when a computing resource occupied by a functional component in the three-dimensional view changes as shown in FIG. 8C to FIG. 8F-2 in the foregoing content, when the two-dimensional view can display an internal structure of a functional component, the two-dimensional graph corresponding to the same functional component in the two-dimensional view is updated in the manner of changing the stereoscopic graph corresponding to the functional component in the three-dimensional view or the manner of changing the three-dimensional graph in the stereoscopic graph. For example, if a height of the stereoscopic graph corresponding to the functional component in the three-dimensional view is increased, a quantity of instances included in the functional component is increased, and a quantity of linear boxes corresponding to a same functional component in the two-dimensional view may be increased. However, if the two-dimensional view does not display the internal structure of the functional component, the three-dimensional view may not be updated.

Step 1503: The display module 130 displays the updated three-dimensional view or two-dimensional view when triggered by the user.

After the construction module 120 updates the two-dimensional view and the three-dimensional view, the display module 130 may perform step 1503. A manner in which the display module 130 performs step 1503 is the same as a manner in which the display module 130 performs step 1203. For details, refer to the foregoing content. Details are not described herein again.

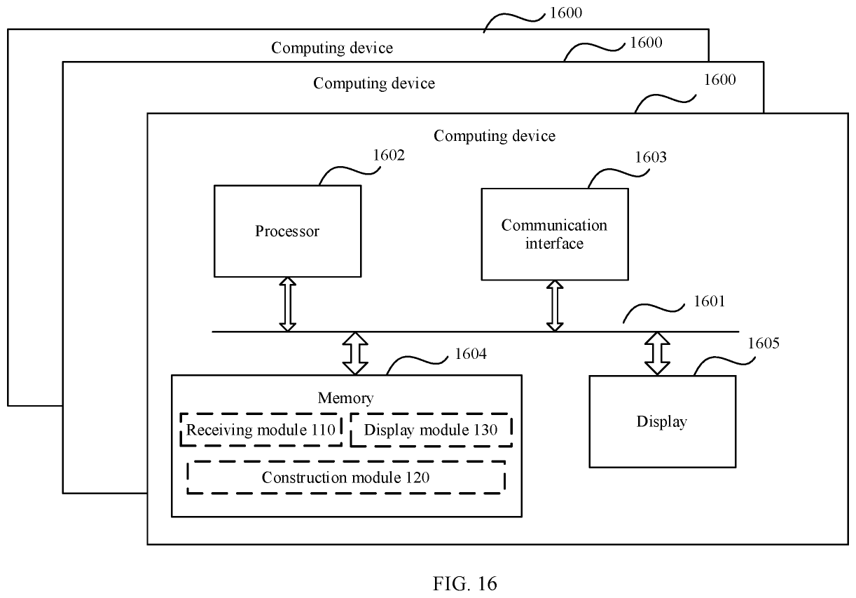

Based on a same inventive concept as the method embodiments, an embodiment of this application further provides a computer cluster, configured to perform the method shown in the foregoing method embodiments. For related features, refer to the foregoing method embodiments. Details are not described herein again. FIG. 16 shows a computer cluster according to an embodiment of this application. The computer cluster includes a plurality of computing devices 1600, and a communication path is established between the computing devices 1600 by using a communication network.

Each computing device 1600 includes a bus 1601, a processor 1602, a communication interface 1603, and a memory 1604. Optionally, the computing device 1600 may further include a display 1605. The processor 1602, the memory 1604, and the communication interface 1603 communicate with each other through the bus 1601.

The processor 1602 may include one or more general-purpose processors, for example, a central processing unit (central processing unit, CPU), or a combination of a CPU and a hardware chip. The hardware chip may be an application-specific integrated circuit (application-specific integrated circuit, ASIC), a programmable logic device (programmable logic device, PLD), or a combination thereof. The PLD may be a complex programmable logic device (complex programmable logic device, CPLD), a field-programmable gate array (field-programmable gate array, FPGA), generic array logic (generic array logic, GAL), or any combination thereof.

The memory 1604 may include a volatile memory (volatile memory), for example, a random access memory (random access memory, RAM). The memory 1604 may further include a non-volatile memory (non-volatile memory, NVM), for example, a read-only memory (read-only memory, ROM), a flash memory, a hard disk drive (hard disk drive, HDD), or a solid-state drive (solid-state drive, SSD). The memory 1604 may further include a combination of the foregoing types.

The memory 1604 stores executable code. The processor 1602 may read the executable code in the memory 1604 to implement a function, and may further communicate with another computing device through the communication interface 1603. The processor 1602 may further trigger the display 1605 to display information to a user, for example, information in FIG. 2Ato FIG. 11 in embodiments of this application. In this embodiment of this application, the processor 1602 may implement functions of one or more modules (for example, one or more of the receiving module 110, the construction module 120, and the display module 130) of the display apparatus 100. In this case, the memory 1604 stores one or more modules (for example, one or more of the receiving module 110, the construction module 120, and the display module 130) of the display apparatus 100.

In this embodiment of this application, the processor 1602 in the plurality of computing devices 1600 may work in coordination, to perform a software code change method that supports a plurality of changes and that is provided in embodiments of this application.

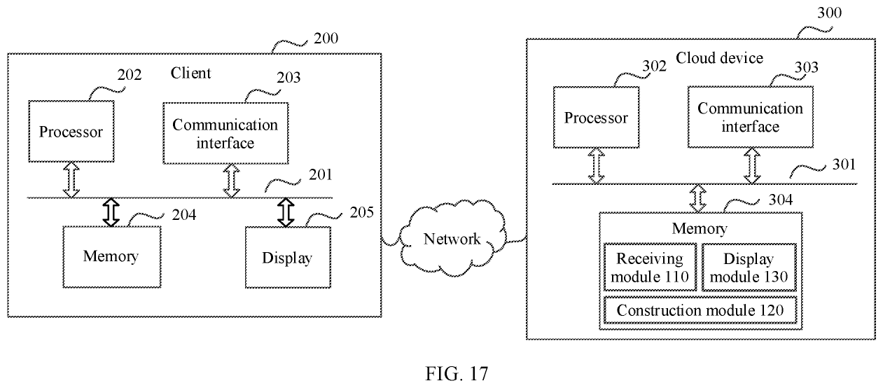

FIG. 17 shows a system architecture according to an embodiment of this application. The system architecture includes a client 200 and a cloud device 300 on which a change apparatus is deployed. The client 200 is connected to the cloud device 300 by using a network. The cloud device 300 is located in a cloud environment, and may be a server or a virtual machine deployed in a cloud data center. FIG. 17 shows only an example in which the change apparatus is deployed on one cloud device 300. In a possible implementation, the change apparatus may be deployed on a plurality of cloud devices 300 in a distributed manner.

As shown in FIG. 17, the client 200 includes a bus 201, a processor 202, a communication interface 203, a memory 204, and a display 205. The processor 202, the memory 204, and the communication interface 203 communicate with each other through the bus 201. For types of the processor 202 and the memory 204, refer to related descriptions of the processor 1602 and the memory 1604. Details are not described herein again. The memory 204 stores executable code, and the processor 202 may read the executable code in the memory 204 to implement a function. The processor 202 may further trigger the display 205 to display information to a user, for example, information in FIG. 2A to FIG. 11 in embodiments of this application. The processor 202 may further communicate with the cloud device through the communication interface 203. For example, the processor 202 may prompt, by using the display 205, the user to enter architecture information of software, and feed back the architecture information to the cloud device 300 through the communication interface 203; and may further receive a three-dimensional view or a two-dimensional view through the communication interface 203, and display the three-dimensional view or the two-dimensional view by using the display 205. For another example, the processor 202 may detect, by using the display 205, an operation of the user on the three-dimensional view, generate update information, and feed back the update information to the cloud device 300 through the communication interface 203; and may further receive an adjusted three-dimensional view or two-dimensional view through the communication interface 203, and display the adjusted three-dimensional view or two-dimensional view by using the display 205.

As shown in FIG. 17, the cloud device 300 includes a bus 301, a processor 302, a communication interface 303, and a memory 304. The processor 302, the memory 304, and the communication interface 303 communicate with each other through the bus 301. For types of the processor 302 and the memory 304, refer to related descriptions of the processor 1602 and the memory 1604. Details are not described herein again. The memory 304 stores executable code. The processor 302 may read the executable code in the memory 304 to implement a function, and may further communicate with the client 200 through the communication interface 303. In this embodiment of this application, the processor 302 may implement functions of the display apparatus 100. In this case, the memory 304 stores one or more of the receiving module 110, the construction module 120, and the display module 130 of the display apparatus 100.

After receiving the architecture information (or the update information) of the software from the client 200 through the communication interface 303, the processor 302 may invoke a module stored in the memory 304 to implement a visualization method for a software architecture provided in embodiments of this application, to generate the three-dimensional view. The processor 302 may send the three-dimensional view to the client 200 through the communication interface 303.

What is claimed is:

1. A visualization method for a software architecture, wherein the method comprises:
constructing a three-dimensional view based on received architecture information of software, and displaying the three-dimensional view, wherein the architecture information of the software indicates that the software comprises at least one functional component, and a stereoscopic graph in the three-dimensional view represents a functional component;
adjusting the three-dimensional view in response to an operation of a user on the three-dimensional view; and
displaying an adjusted three-dimensional view.

2. The method according to claim 1, wherein the adjusting the three-dimensional view in response to an operation of a user on the three-dimensional view comprises:
updating the architecture information of the software in response to the operation of the user on the three-dimensional view; and
adjusting the three-dimensional view based on updated architecture information of the software.

3. The method according to claim 1, wherein the architecture information of the software comprises at least one of the following: a name of the functional component in the software, an association relationship between functional components in the software, a computing resource occupied by the functional component, and an affiliation relationship between the functional components in the software.

4. The method according to claim 1, wherein the displayed three-dimensional view indicates at least one of the following:
a connection line between stereoscopic graphs in the three-dimensional view is used to indicate the association relationship between functional components in the software, the stereoscopic graph in the three-dimensional view indicates the computing resource occupied by the functional component in the software, and an inclusion relationship between the stereoscopic graphs in the three-dimensional view is used to indicate the affiliation relationship between the functional components in the software.

5. The method according to claim 1, wherein the stereoscopic graph in the three-dimensional view indicates the computing resource occupied by the functional component in the software, and the adjusting the three-dimensional view in response to an operation of a user on the three-dimensional view comprises:
scaling the stereoscopic graph in response to a scaling operation of the user on the stereoscopic graph in the three-dimensional view, to adjust the computing resource occupied by the functional component corresponding to the stereoscopic graph.

6. The method according to claim 5, wherein an edge of the stereoscopic graph is used to indicate the computing resource occupied by the functional component, and the scaling the stereoscopic graph in response to a scaling operation of the user on the stereoscopic graph in the three-dimensional view comprises:
stretching the edge in response to a stretching operation of the user on the edge of the stereoscopic graph in the three-dimensional view, to adjust the computing resource corresponding to the edge occupied by the functional component corresponding to the stereoscopic graph; or
in response to a stretching operation of the user on a vertex of the stereoscopic graph in the three-dimensional view, proportionally scaling all edges of the stereoscopic graph in a direction of the stretching operation, to adjust a computing resource corresponding to each edge occupied by the functional component corresponding to the stereoscopic graph.

7. The method according to claim 1, wherein the stereoscopic graph in the three-dimensional view comprises a three-dimensional graph, and a three-dimensional graph comprised in a stereoscopic graph indicates an instance in a functional component corresponding to the stereoscopic graph; and the adjusting the three-dimensional view in response to an operation of a user on the three-dimensional view comprises:
scaling the three-dimensional graph in response to a scaling operation of the user on the three-dimensional graph in the three-dimensional view, to adjust a computing resource occupied by the instance indicated by the three-dimensional graph.

8. The method according to claim 1, wherein after the adjusting the three-dimensional view, the method further comprises:
updating a two-dimensional view based on the adjusted three-dimensional view, wherein the two-dimensional view is pre-constructed and is used to display the software architecture, and a two-dimensional graph in the two-dimensional view represents the functional component; and
displaying an updated two-dimensional view.

9. A computing device, wherein the computing device comprises a processor and a memory, wherein
the memory is configured to store computer program instructions; and
the processor coupled to the memory to execute the instructions to:
construct a three-dimensional view based on received architecture information of software, and displaying the three-dimensional view, wherein the architecture information of the software indicates that the software comprises at least one functional component, and a stereoscopic graph in the three-dimensional view represents a functional component;
adjust the three-dimensional view in response to an operation of a user on the three-dimensional view; and
display an adjusted three-dimensional view.

10. The computing device according to claim 9, wherein the processor coupled to the memory to further execute the instructions to:
update the architecture information of the software in response to the operation of the user on the three-dimensional view; and
adjust the three-dimensional view based on updated architecture information of the software.

11. The computing device according to claim 10, wherein the architecture information of the software comprises at least one of the following: a name of the functional component in the software, an association relationship between functional components in the software, a computing resource occupied by the functional component, and an affiliation relationship between the functional components in the software.

12. A computing device cluster, wherein the computing device cluster comprises a plurality of computing devices, each computing device comprises a processor and a memory, and a memory in at least one computing device is configured to store computer program instructions; and
a processor in the at least one computing device coupled to the memory to execute the instructions to:
construct a three-dimensional view based on received architecture information of software, and displaying the three-dimensional view, wherein the architecture information of the software indicates that the software comprises at least one functional component, and a stereoscopic graph in the three-dimensional view represents a functional component;
adjust the three-dimensional view in response to an operation of a user on the three-dimensional view; and
display an adjusted three-dimensional view.

13. The computing device cluster according to claim 12, wherein the processor in the at least one computing device coupled to the memory to further execute the instructions to:
update the architecture information of the software in response to the operation of the user on the three-dimensional view; and
adjust the three-dimensional view based on updated architecture information of the software.

14. The computing device cluster according to claim 13, wherein the architecture information of the software comprises at least one of the following: a name of the functional component in the software, an association relationship between functional components in the software, a computing resource occupied by the functional component, and an affiliation relationship between the functional components in the software.
